(19) United States
(12) Patent Application Publication
(10) Pub. No.: US 2018/0265146 A1
(43) Pub. Date: Sep. 20, 2018

(54) TRACK SYSTEM FOR TRACTION OF AN OFF-ROAD VEHICLE SUCH AS AN ALL-TERRAIN VEHICLE (ATV) OR A SNOWMOBILE

(71) Applicant: CAMSO INC., Magog (CA)

(72) Inventors: Guillaume LAPLANTE, Sherbrooke (CA); Slim FRIKHA, Otterburn Park (CA)

(21) Appl. No.: 15/541,671

(22) PCT Filed: Jan. 5, 2016
(86) PCT No.: PCT/CA2016/050007

§ 371 Date: Jul. 5, 2017

Related U.S. Application Data
(60) Provisional application No. 62/099,871, filed on Jan. 5, 2015.

(51) Int. Cl. B62D 55/26; B62D 55/24; B62M 27/02; B62D 55/125; B62D 55/14

(52) U.S. Cl. CPC B62D 55/26; B62D 55/244; B62M 2027/027; B62D 55/125; B62D 55/14; B62M 27/02

(57) ABSTRACT

A track system for traction of an off-road vehicle, such as an all-terrain vehicle (ATV) or a snowmobile. The track system may have various features to enhance its traction and/or other aspects of its performance, including, for example, an improved capability to compact, contain and/or otherwise manage snow or other ground matter (e.g., soil, mud, sand, etc.) on which the off-road vehicle travels.

### CROSS-REFERENCE TO RELATED APPLICATION

This application claims priority from U.S. Provisional Patent Application 62/099,871 filed on Jan. 5, 2015 and hereby incorporated by reference herein.

### FIELD OF THE INVENTION

The invention relates generally to off-road vehicles such as all-terrain vehicles (ATVs) and snowmobiles and, more particularly, to track systems for providing traction to ATVs, snowmobiles and other off-road vehicles.

### BACKGROUND

Certain off-road vehicles, such as snowmobiles and all-terrain vehicles (ATVs), may be equipped with track systems which enhance their traction and floatation on soft, slippery and/or irregular grounds (e.g., soil, mud, sand, ice, snow, etc.) on which they operate

Traction, floatation and other performance aspects of tracked vehicles depend on various factors, including their track systems.

For example, characteristics of a track that allow it to manage snow or other ground matter (e.g., soil, mud, sand, etc.) on which travels a vehicle propelled by the track can have a significant influence on traction, floatation and/or other performance aspects of the vehicle. For instance, compaction of snow or other ground matter by the track as the vehicle travels can affect a tractive force applied by the track onto the ground surface on which it travels. Proper containment of the snow or other ground matter beneath the track can similarly affect the vehicle's performance.

For these and other reasons, there is a need to improve track systems for ATVs, snowmobiles and other off-road vehicles.

### SUMMARY OF THE INVENTION

In various embodiments of the invention, a track system for traction of an off-road vehicle may have various features to enhance its traction and/or other aspects of its performance, including, for example, an improved capability to compact, contain and/or otherwise manage snow or other ground matter (e.g., soil, mud, sand, etc.) on which the off-road vehicle travels.

For example, according to an aspect of the invention, there is provided a track for traction of an off-road vehicle. The track is mountable around a plurality of track-contacting wheels which includes a drive wheel for driving the track. The track comprises elastomeric material allowing the track to flex around the track-contacting wheels. The track comprises: an inner surface for facing the track-contacting wheels; a ground-engaging outer surface for engaging the ground; a plurality of traction projections projecting from the ground-engaging outer surface and distributed in a longitudinal direction of the track; and a plurality of compaction projections projecting from the ground-engaging outer surface to compact matter on the ground.

According to another aspect of the invention, there is provided a track for traction of an off-road vehicle. The track is mountable around a plurality of track-contacting wheels which includes a drive wheel for driving the track. The track comprises elastomeric material allowing the track to flex around the track-contacting wheels. The track comprises: an inner surface for facing the track-contacting wheels; a ground-engaging outer surface for engaging the ground; a plurality of traction projections projecting from the ground-engaging outer surface and distributed in a longitudinal direction of the track; and; and a plurality of containment barriers projecting from the ground-engaging outer surface to block lateral flow of matter on the ground beyond the track.

According to another aspect of the invention, there is provided a track for traction of an off-road vehicle. The track is mountable around a plurality of track-contacting wheels which includes a drive wheel for driving the track. The track comprises elastomeric material allowing the track to flex around the track-contacting wheels. The track comprises: an inner surface for facing the track-contacting wheels; a ground-engaging outer surface for engaging the ground; a plurality of traction projections projecting from the ground-engaging outer surface and distributed in a longitudinal direction of the track; a plurality of compaction projections projecting from the ground-engaging outer surface to compact matter on the ground; and a plurality of containment barriers projecting from the ground-engaging outer surface to block lateral flow of the matter on the ground beyond the track.

According to another aspect of the invention, there is provided a track system for traction of an off-road vehicle. The track system comprises a track comprising: elastomeric material allowing the track to flex when moving around the track system; a ground-engaging outer surface for engaging the ground; an inner surface opposite to the ground-engaging outer surface; and a plurality of traction projections projecting from the ground-engaging outer surface and distributed in a longitudinal direction of the track. The track system comprises a plurality of wheels around which the track is disposed. The plurality of wheels comprises a drive wheel for driving the track and a plurality of idler wheels. A distance in a widthwise direction of the track system between laterally-adjacent ones of the idler wheels varies in a longitudinal direction of the track system.

According to another aspect of the invention, there is provided a track system for traction of an off-road vehicle. The track system comprises a track comprising: elastomeric material allowing the track to flex when moving around the track system; a ground-engaging outer surface for engaging the ground; an inner surface opposite to the ground-engaging outer surface; and a plurality of traction projections projecting from the ground-engaging outer surface and distributed in a longitudinal direction of the track. The track system comprises a plurality of sliders for sliding on the inner surface of the track along a bottom run of the track. The track is free of slider-engaging members spaced apart in the longitudinal direction of the track for engagement with the sliders.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIGS. 1A and 1B show an example of an all-terrain vehicle (ATV) comprising track systems in accordance with an embodiment of the invention;

FIGS. 2A and 2B show the ATV equipped with ground-engaging wheels instead of the track systems;

FIGS. 3 and 4 show perspective views of a front one and a rear one of the track systems;

FIGS. 5 and 6 show perspective views of the front one and the rear one of the track systems without their track;

FIGS. 7 and 8 show perspective views of a segment of the track of the rear track system, which depict features of an inner side and a ground-engaging outer side of the track that are not depicted in FIGS. 1A, 1B, 3 and 4, including traction projections of the track;

FIGS. 9 and 10 show views of the ground-engaging outer side and the inner side of the track of the rear track system;

FIG. 11 shows a side view of the track of the rear track system;

FIG. 12 shows a partial cross-sectional view of the track of the rear track system;

FIG. 13 shows a partial cross-sectional view of a variant of the track of the rear track system;

FIGS. 14 to 18 show views of a segment of the track of the front track system, which depict features of an inner side and a ground-engaging outer side of the track that are not depicted in FIGS. 1A, 1B, 3 and 4;

FIG. 19 shows an example of an embodiment in which the track comprises compaction projections;

FIG. 20 shows a side view of a portion of the track including a compaction projection;

FIG. 21 shows a perspective view of a compaction projection of the track;

FIG. 22 shows an example of an embodiment in which the track comprises containment barriers;

FIG. 23 shows a perspective view of a containment barrier of the track;

FIG. 24 shows a variant of the containment barriers;

FIG. 25 shows an example of an embodiment in which the track comprises containment barriers and compaction projections;

FIG. 26 shows a perspective view of a containment barrier of the track shown in FIG. 25; and

FIG. 27 shows a top view of two idler wheels of the track system that are laterally-adjacent to one another;

FIG. 28 shows an example of an embodiment where some of the idler wheels that are laterally-adjacent to one another define a lateral distance between them that decreases in a front-to-rear direction of the track system;

FIG. 29 shows another embodiment in which the lateral distance of a different number of laterally-adjacent idler wheels decreases in the front-to-rear direction of the track system;

FIG. 30 shows a prior art track system where the distance between laterally-adjacent idler wheels of the track system is uniform for all laterally-adjacent idler wheels;

FIG. 31 shows the track of the track system of FIG. 28 bending at a center of the track between laterally-adjacent idler wheels defining an enlarged lateral distance between them;

FIG. 32 shows a variant in which the track system comprises additional idler wheels defining a uniform lateral distance between them;

FIG. 33 shows an example of an embodiment where sliders slide against the inner side of the track in place of the idler wheels;

FIG. 34 shows a cross-sectional view of the sliders and the track of the track system of FIG. 33;

FIG. 35 shows a top inner view of the track system of FIG. 33, including the sliders and slide paths of the track system; and

FIG. 36 shows an example of a snowmobile comprising a track system in accordance with another embodiment of the invention.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

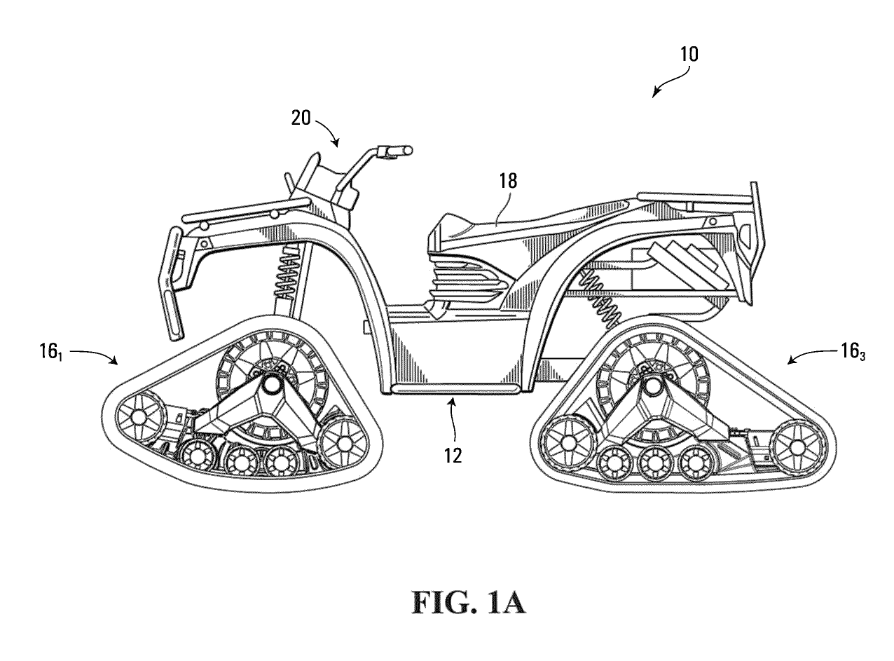

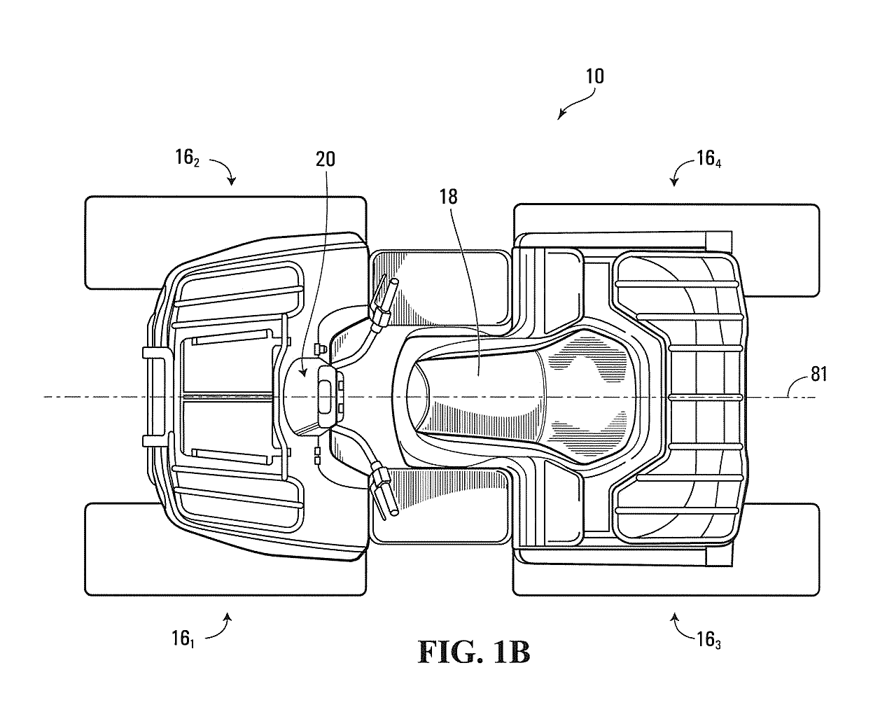

FIGS. 1A and 1B show an example of an all-terrain vehicle (ATV) 10 in accordance with an embodiment of the invention. The ATV 10 is a small open vehicle designed to travel off-road on a variety of terrains, including roadless rugged terrain, for recreational, utility and/or other purposes.

In this embodiment, the ATV 10 comprises a prime mover 12, a plurality of track systems 16₁-16₄, a seat 18, and a user interface 20, which enable a user of the ATV to ride the ATV 10 on the ground.

As further discussed later, in various embodiments, the track systems 16₁-16₄ may have various features to enhance their traction and/or other aspects of their performance, including, for example, an improved capability to compact, contain and/or otherwise manage snow or other ground matter (e.g., soil, mud, sand, etc.) on which the ATV 10 travels.

The prime mover 12 is a source of motive power that comprises one or more motors. For example, in this embodiment, the prime mover 12 comprises an internal combustion engine. In other embodiments, the prime mover 12 may comprise another type of motor (e.g., an electric motor) or a combination of different types of motor (e.g., an internal combustion engine and an electric motor).

The prime mover 12 is in a driving relationship with one or more of the track systems 16₁-16₄. That is, motive power generated by the prime mover 12 is transmitted to one or more of the track systems 16₁-16₂ via a powertrain of the ATV 10 (e.g., via a transmission and a differential of the powertrain).

In this case, the seat 18 is a straddle seat and the ATV 10 is usable by a single person such that the seat 18 accommodates only that person driving the ATV 10. In other cases, the seat 18 may be another type of seat, and/or the ATV 10 may be usable by two individuals, namely one person driving the ATV 10 and a passenger, such that the seat 18 may accommodate both of these individuals (e.g., behind one another or side-by-side) or the ATV 10 may comprise an additional seat for the passenger. For example, in other embodiments, the ATV 10 may be a side-by-side ATV, sometimes referred to as a “utility terrain vehicle” or “UTV”.

The user interface 20 allows the user to interact with the ATV 10. More particularly, the user interface 20 comprises an accelerator, a brake control, and a steering device that are operated by the user to control motion of the ATV 10 on the ground. In this case, the steering device comprises handlebars. In other cases, the steering device may comprise a steering wheel or other type of steering element. The user interface 20 also comprises an instrument panel (e.g., a dashboard) which provides indicators (e.g., a speedometer indicator, a tachometer indicator, etc.) to convey information to the user.

The track systems 16₁-16₄ engage the ground to provide traction to the ATV 10. More particularly, in this example, front ones of the track systems 16₁-16₄ provide front traction to the ATV 10 while rear ones of the track systems 16₁-16₄ provide rear traction to the ATV 10. Each of the front ones of the track systems 16₁-16₄ is pivotable about a steering axis of the ATV 10 in response to input of the user at the handlebars in order to steer the ATV 10 on the ground.

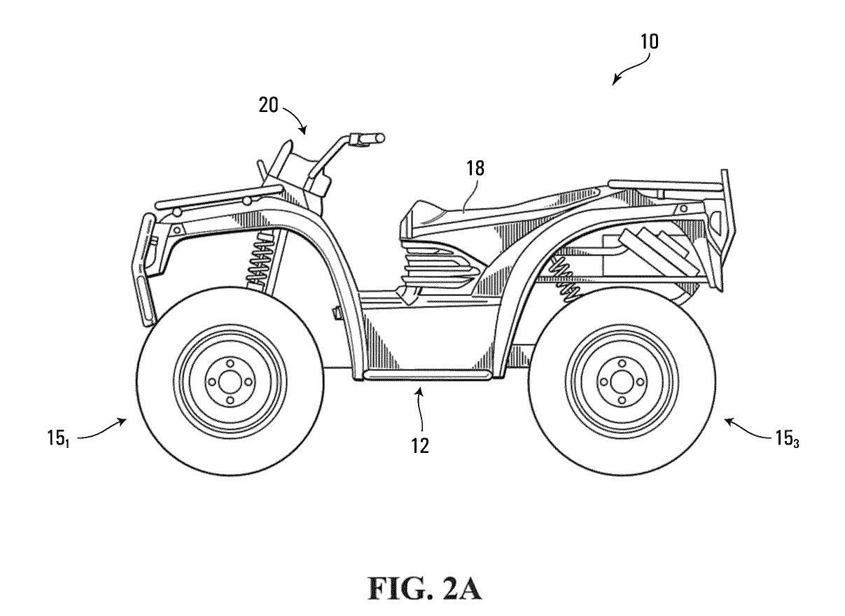

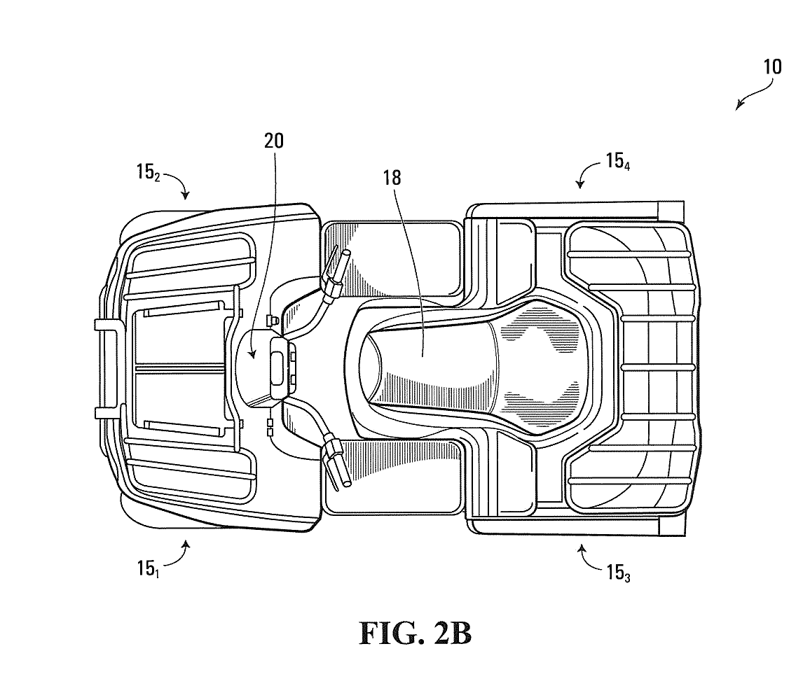

In this embodiment, each track system 16ᵢ is mounted in place of a ground-engaging wheel that may otherwise be mounted at a position of the track system 16₁ to propel the ATV 10 on the ground. For example, as shown in FIGS. 2A and 2B, the ATV 10 may be propelled on the ground by four ground-engaging wheels 15₁-15₄ with tires instead of the track systems 16₁-16₄. Basically, in this embodiment, the track systems 16₁-16₄ may be used to convert the ATV 10 from a wheeled vehicle into a tracked vehicle, thereby enhancing its traction and floatation on the ground.

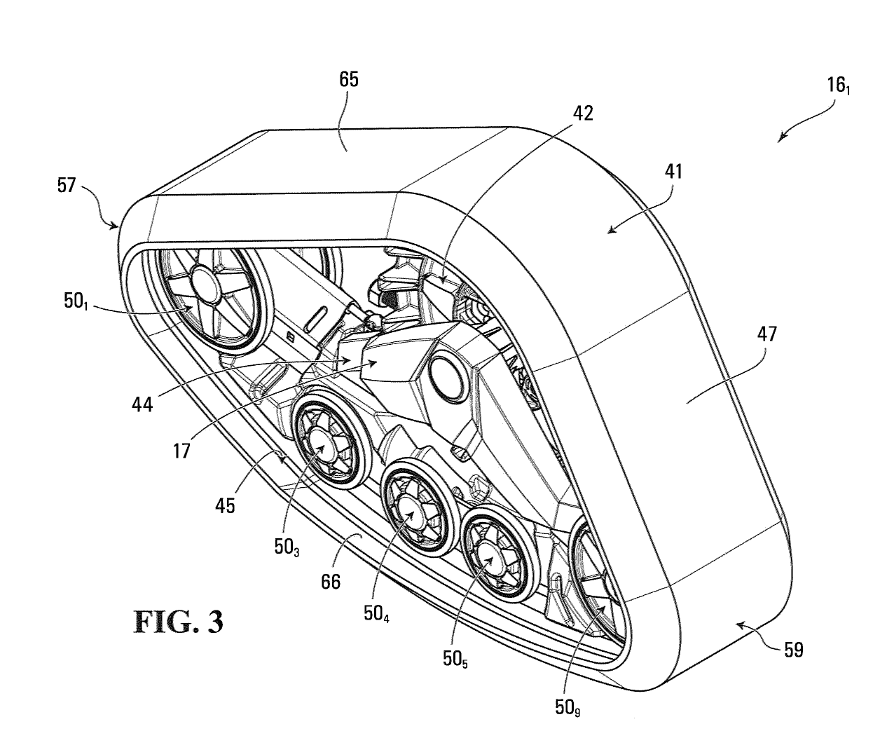

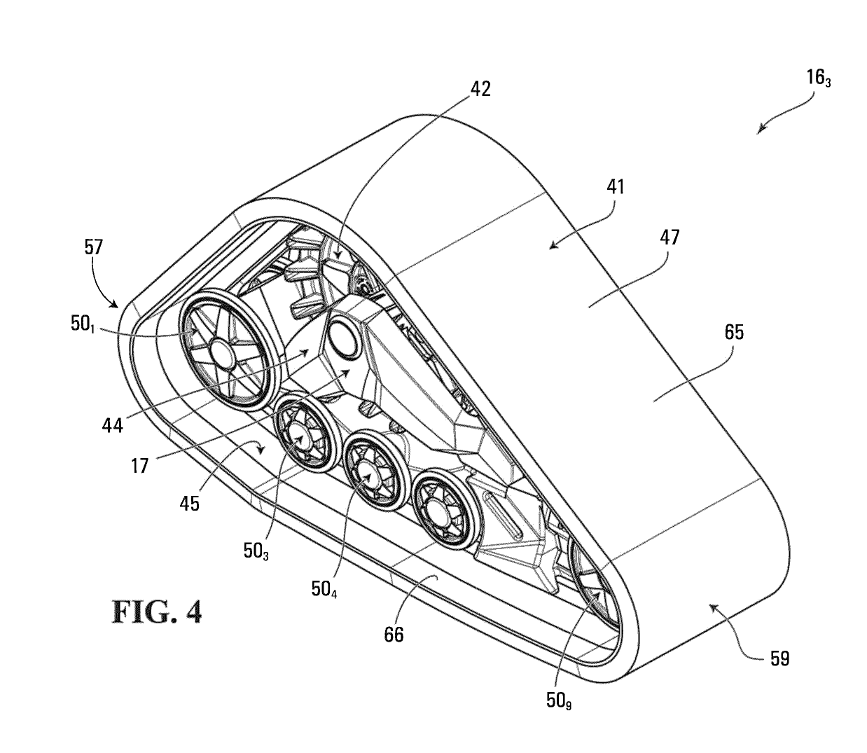

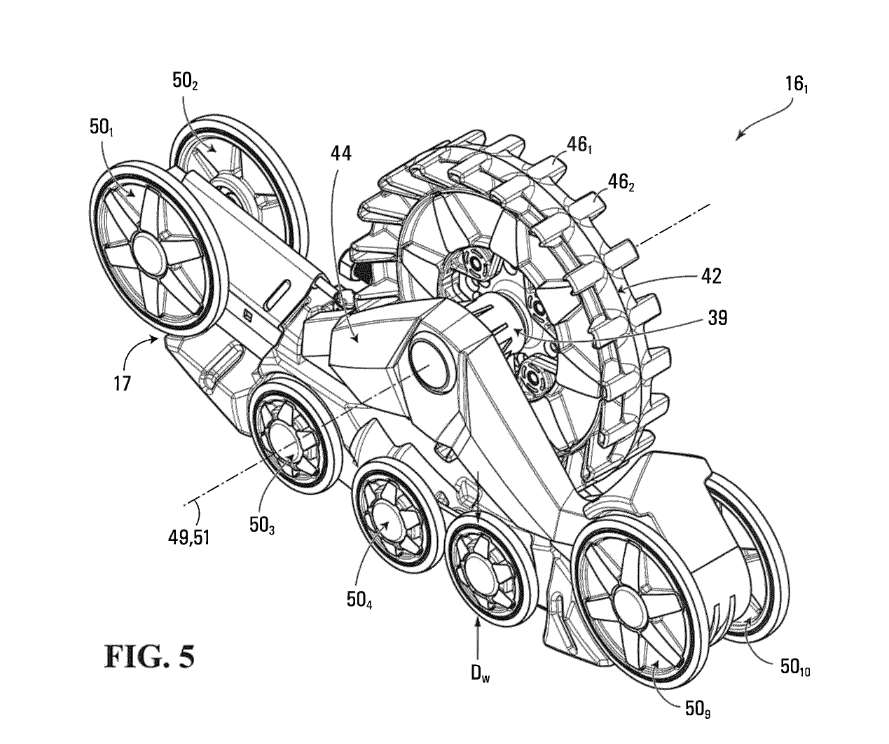

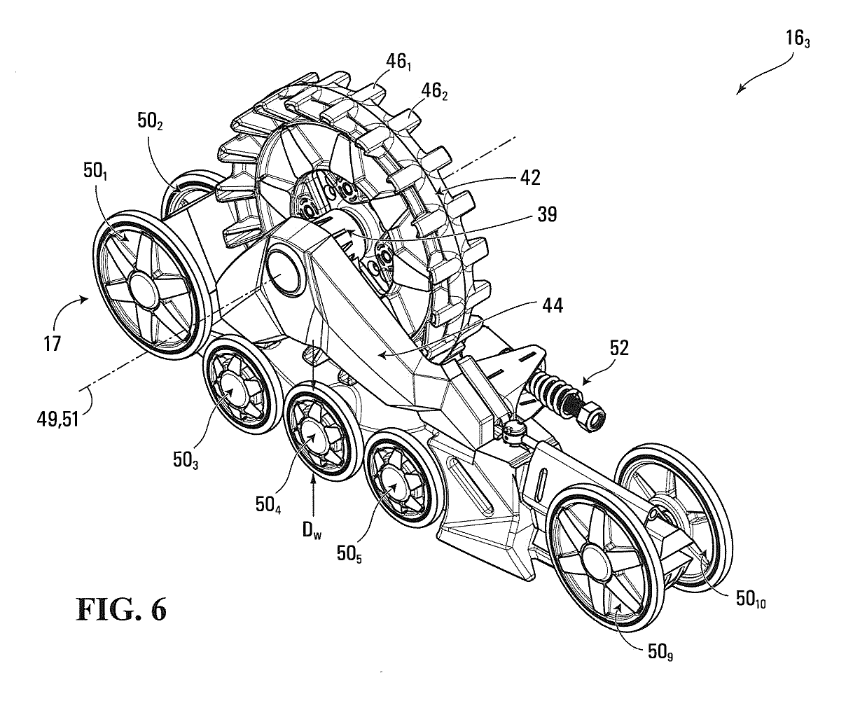

With additional reference to FIGS. 3 to 6, in this embodiment, each track system 16ᵢ comprises a track-engaging assembly 17 and a track 41 disposed around the track-engaging assembly 17. In this example, the track-engaging assembly 17 comprises a frame 44 and a plurality of track-contacting wheels which includes a drive wheel 42 and a plurality of idler wheels 50₁-50₁₀. The track system 16ᵢ has a front longitudinal end 57 and a rear longitudinal end 59 that define a length of the track system 16ᵢ. A width of the track system 16ᵢ is defined by a width W_{T} of the track 41. An envelope of the track system 16ᵢ is defined by a length of the track 41. The track system 16ᵢ has a longitudinal direction, a widthwise direction, and a height direction.

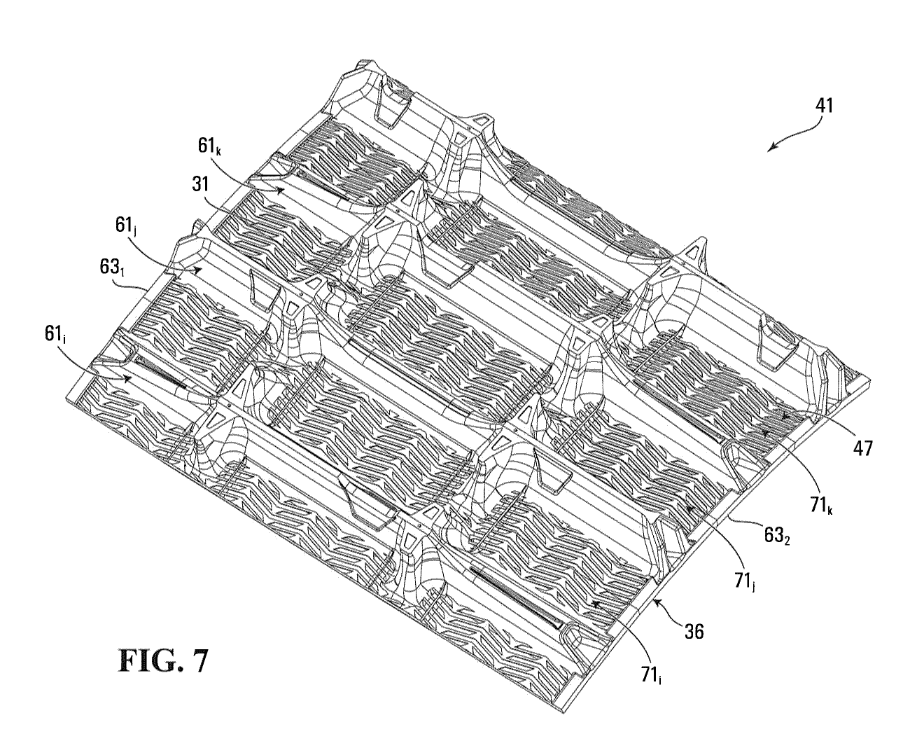

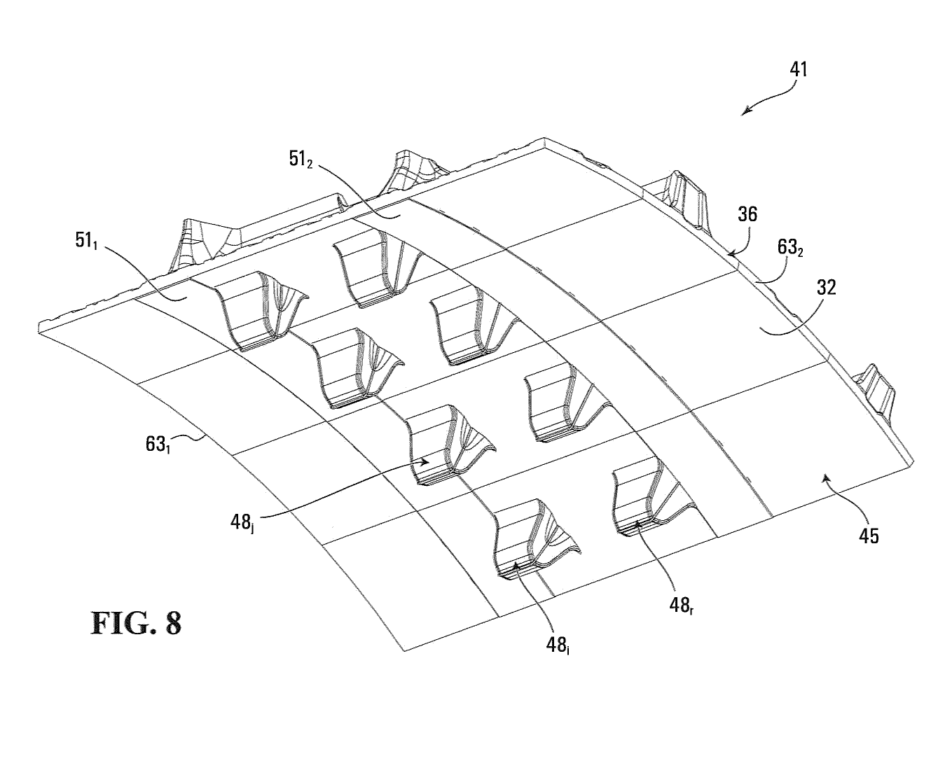

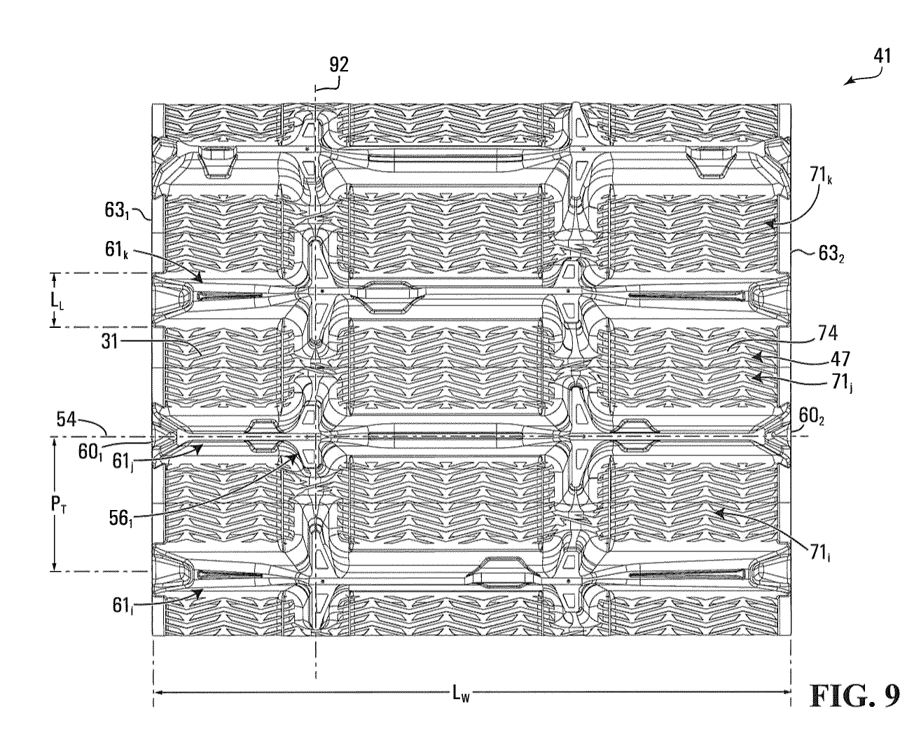

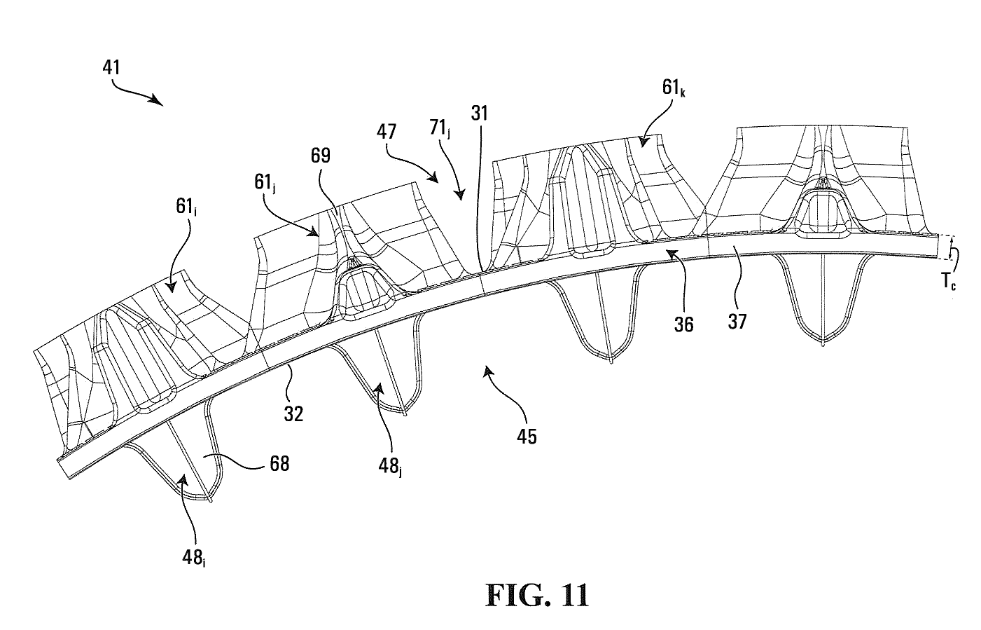

The track 41 engages the ground to provide traction to the ATV 10. The length of the track 41 allows the track 41 to be mounted around the track-engaging assembly 17. In view of its closed configuration without ends that allows it to be disposed and moved around the track-engaging assembly 17, the track 41 can be referred to as an “endless” track. Referring additionally to FIGS. 7 to 11, the track 41 comprises an inner side 45 facing the wheels 42, 50₁-50₁₀ and defining an inner area of the track 41 in which these wheels are located. The track 41 also comprises a ground-engaging outer side 47 opposite the inner side 45 for engaging the ground on which the ATV 10 travels. Lateral edges 63₁, 63₂ of the track 41 define the track's width W_{T}. The track 41 has a top run 65 which extends between the longitudinal ends 57, 59 of the track system 16ᵢ and over the drive wheel 42, and a bottom run 66 which extends between the longitudinal ends 57, 59 of the track system 16ᵢ and under the idler wheels 50₁-50₁₀. The track 41 has a longitudinal direction, a widthwise direction, and a thickness direction.

The track 41 is elastomeric in that it comprises elastomeric material allowing it to flex around the wheels 42, 50₁-50₁₀. The elastomeric material of the track 41 can include any polymeric material with suitable elasticity. In this embodiment, the elastomeric material includes rubber. Various rubber compounds may be used and, in some cases, different rubber compounds may be present in different areas of the track 41. In other embodiments, the elastomeric material of the track 41 may include another elastomer in addition to or instead of rubber (e.g., polyurethane elastomer). The track 41 can be molded into shape in a mold by a molding process during which its elastomeric material is cured.

More particularly, the track 41 comprises an elastomeric belt-shaped body 36 underlying its inner side 45 and its ground-engaging outer side 47. In view of its underlying nature, the body 36 can be referred to as a “carcass”. The carcass 36 comprises elastomeric material 37 which allows the track 41 to flex around the wheels 42, 50₁-50₁₀.

As shown in FIG. 12, in this embodiment, the carcass 36 comprises a plurality of reinforcements embedded in its elastomeric material 37. One example of a reinforcement is a layer of reinforcing cables 38₁-38_{C} that are adjacent to one another and that extend in the longitudinal direction of the track 41 to enhance strength in tension of the track 41 along its longitudinal direction. In some cases, a reinforcing cable may be a cord or wire rope including a plurality of strands or wires. In other cases, a reinforcing cable may be another type of cable and may be made of any material suitably flexible longitudinally (e.g., fibers or wires of metal, plastic or composite material). Another example of a reinforcement is a layer of reinforcing fabric 40. Reinforcing fabric comprises pliable material made usually by weaving, felting, or knitting natural or synthetic fibers. For instance, a layer of reinforcing fabric may comprise a ply of reinforcing woven fibers (e.g., nylon fibers or other synthetic fibers). Various other types of reinforcements may be provided in the carcass 36 in other embodiments.

The carcass 36 may be molded into shape in the track's molding process during which its elastomeric material 37 is cured. For example, in this embodiment, layers of elastomeric material providing the elastomeric material 37 of the carcass 36, the reinforcing cables 38₁-38_{C} and the layer of reinforcing fabric 40 may be placed into the mold and consolidated during molding.

In this embodiment, the inner side 45 of the track 41 comprises an inner surface 32 of the carcass 36 and a plurality of wheel-contacting projections 48₁-48_{N} that project from the inner surface 32 to contact at least some of the wheels 42, 50₁-50₁₀ and that are used to do at least one of driving (i.e., imparting motion to) the track 41 and guiding the track 41. In that sense, the wheel-contacting projections 48₁-48_{N} can be referred to as “drive/guide projections”, meaning that each drive/guide projection is used to do at least one of driving the track 41 and guiding the track 41. Also, such drive/guide projections are sometimes referred to as “drive/guide lugs” and will thus be referred to as such herein. More particularly, in this embodiment, the drive/guide lugs 48₁-48_{N} interact with the drive wheel 42 in order to cause the track 41 to be driven, and also interact with the idler wheels 50₁-50₁₀ in order to guide the track 41 as it is driven by the drive wheel 42. The drive/guide lugs 48₁-48_{N} are thus used to both drive the track 41 and guide the track 41 in this embodiment.

The drive/guide lugs 48₁-48_{N} are spaced apart along the longitudinal direction of the track 41. In this case, the drive/guide lugs 48₁-48_{N} are arranged in a plurality of rows that are spaced apart along the widthwise direction of the track 41. The drive/guide lugs 48₁-48_{N} may be arranged in other manners in other embodiments (e.g., a single row or more than two rows). Each of the drive/guide lugs 48₁-48_{N} is an elastomeric drive/guide lug in that it comprises elastomeric material 68. The drive/guide lugs 48₁-48_{N} can be provided and connected to the carcass 36 in the mold during the track's molding process.

The ground-engaging outer side 47 of the track 41 comprises a ground-engaging outer surface 31 of the carcass 36 and a plurality of traction projections 61₁-61_{M} that project from the outer surface 31 and engage and may penetrate into the ground to enhance traction. The traction projections 61₁-61_{M}, which can sometimes be referred to as “traction lugs” or “traction profiles”, are spaced apart in the longitudinal direction of the track system 16ᵢ. The ground-engaging outer side 47 comprises a plurality of traction-projection-free areas 71₁-71_{F} (i.e., areas free of traction projections) between successive ones of the traction projections 61₁-61_{M}. In this example, each of the traction projections 61₁-61_{M} is an elastomeric traction projection in that it comprises elastomeric material 69. The traction projections 61₁-61_{M} can be provided and connected to the carcass 36 in the mold during the track's molding process.

Each traction projection 61ᵢ extends transversally to the longitudinal direction of the track 41. That is, the traction projection 61ᵢ has a longitudinal axis 54 extending transversally to the longitudinal direction of the track 41. In this example, the longitudinal axis 54 of the traction projection 61ᵢ is substantially parallel to the widthwise direction of the track 41. In other examples, the longitudinal axis 54 of the traction projection 61ᵢ may be transversal to the longitudinal direction of the track 41 without being parallel to the widthwise direction of the track 41.

In this embodiment, the traction projection 61ᵢ extends across at least a majority of the width W_{T} of the track 41. More particularly, in this example, the traction projection 61ᵢ extends across substantially an entirety of the width W_{T} of the track 41. The traction projection 61ₓ has longitudinal ends 60₁, 60₂ adjacent to respective ones of the lateral edges 63₁, 63₂ of the track 41. The traction projection 61ᵢ may extend across any suitable part of the width W_{T} of the endless track 41 in other embodiments.

Also, in this embodiment, the traction projection 61ᵢ varies in cross-sectional shape along its longitudinal axis 54. That is, cross-sections of the traction projection 61ᵢ at different positions along the longitudinal axis 54 of the traction projection 61ᵢ are different.

The traction projections 61₁-61_{M} may be configured in various other ways in other embodiments.

In this example, the carcass 36 has a thickness T_{c} which is relatively small. The thickness T_{c} of the carcass 36 is measured from the inner surface 32 to the ground-engaging outer surface 31 of the carcass 36 between longitudinally-adjacent ones of the traction projections 61₁-61_{M}. For example, in some embodiments, the thickness T_{c} of the carcass 36 may be no more than 0.375 inches, in some cases no more than 0.325 inches, in some cases no more than 0.275 inches, in some cases no more than 0.225 inches, in some cases no more than 0.200 inches, and in some cases even less (e.g., 0.180 or 0.170 inches). The thickness T_{c} of the carcass 36 may have any other suitable value in other embodiments.

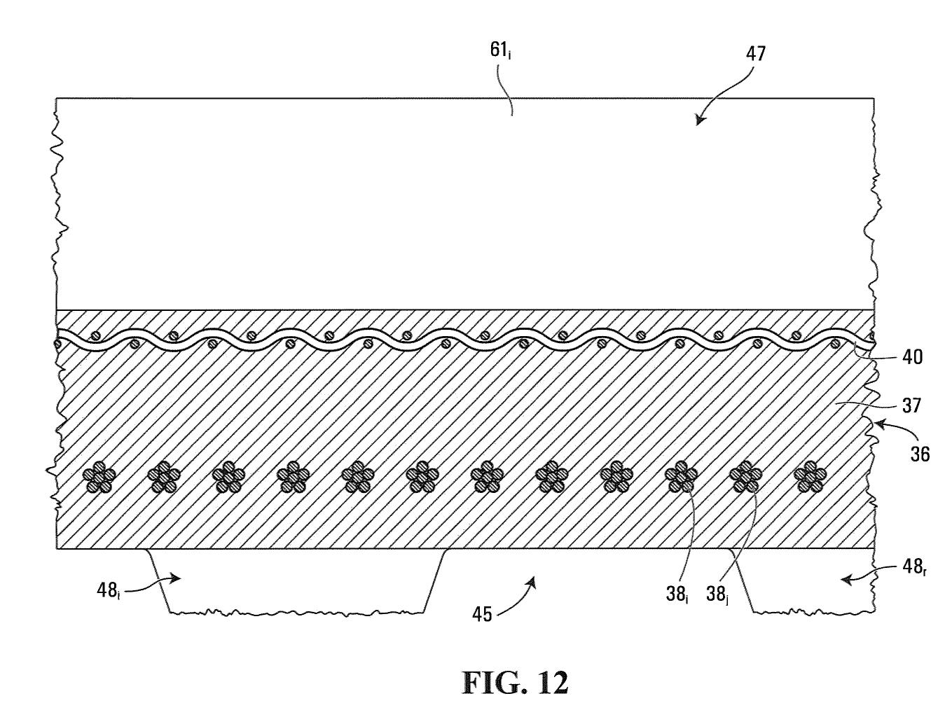

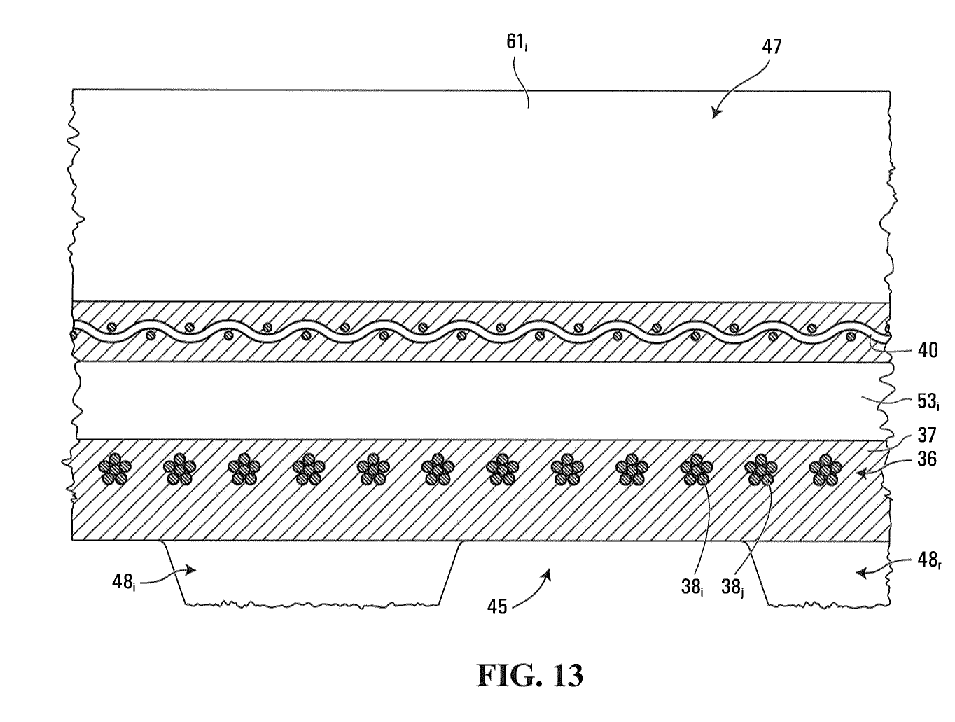

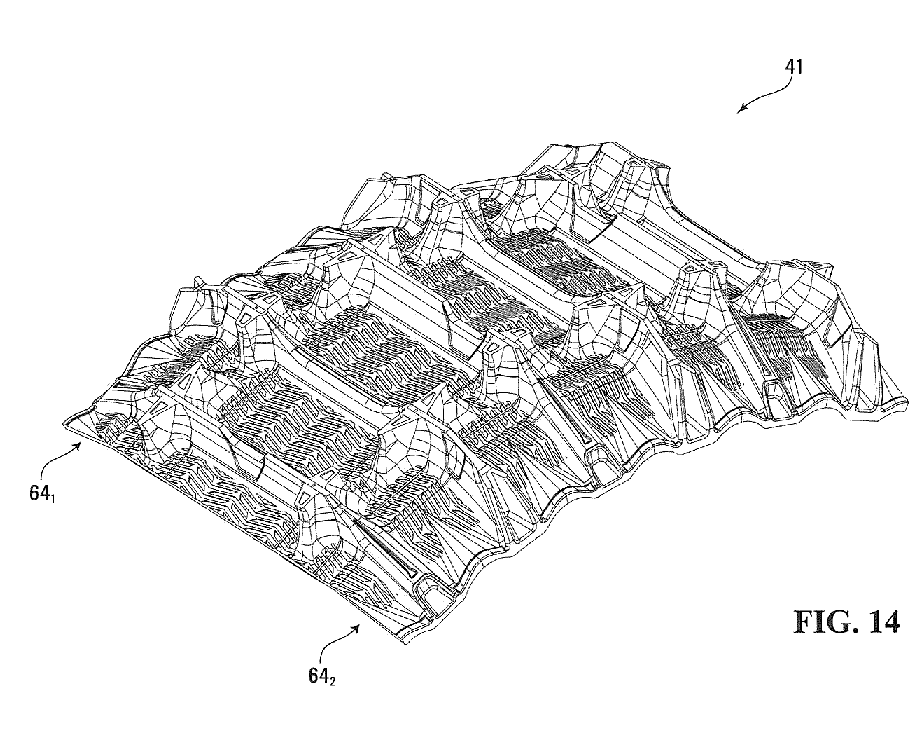

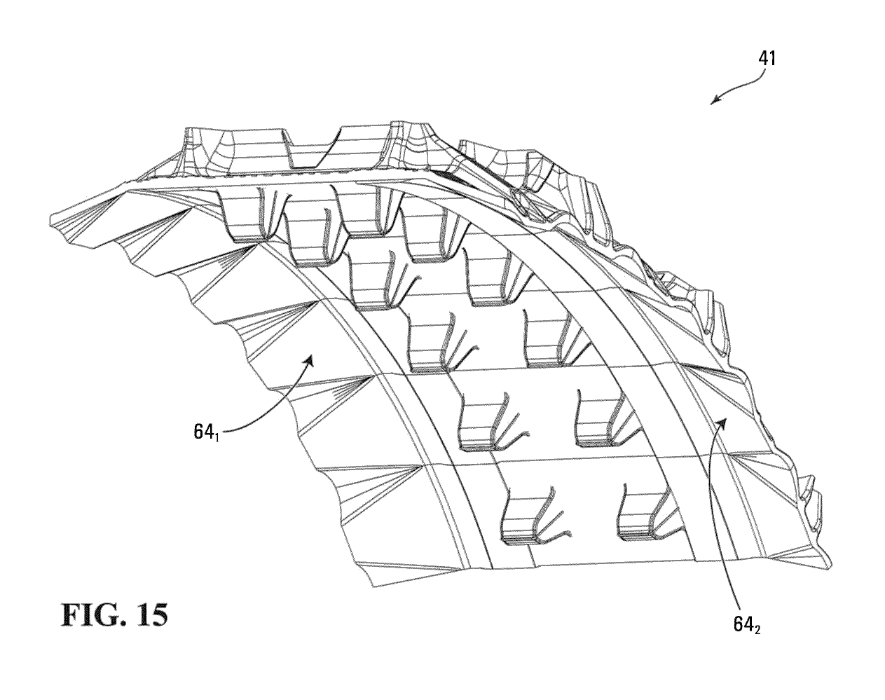

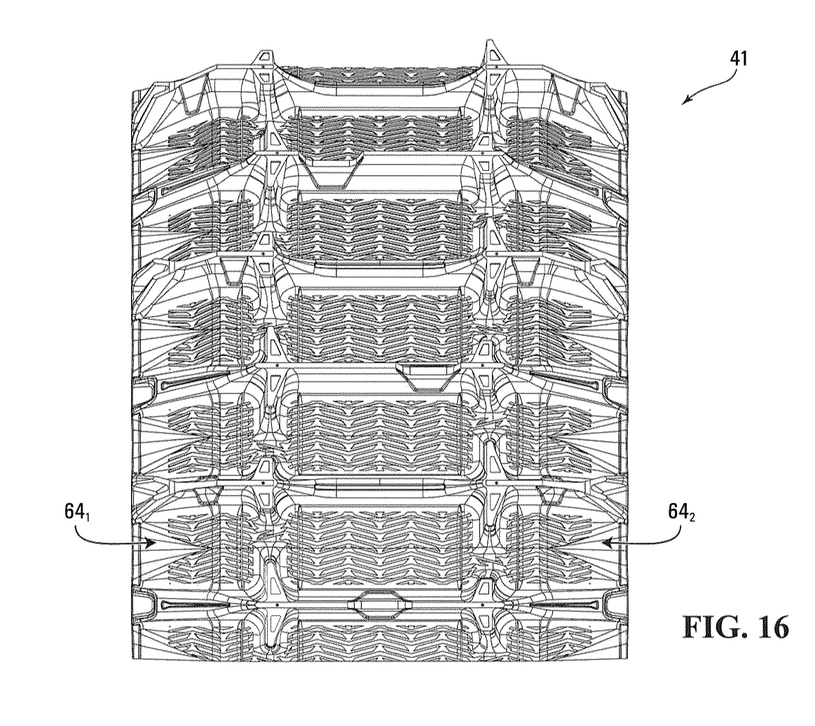

In this embodiment, as shown in FIG. 12, the track 41 is free of transversal stiffening rods embedded in its elastomeric material. That is, the track 41 does not comprise transversal stiffening rods embedded in its elastomeric material and extending transversally to its longitudinal direction. FIG. 13 shows a variant in which the track 41 may comprise transversal stiffening rods 53₁-53_{M} embedded in its elastomeric material and extending transversally to its longitudinal direction in other embodiments. This absence of transversal stiffening rods makes the track 41 more flexible in its widthwise direction than if the track 41 had the transversal stiffening rods 53₁-53ₘ but was otherwise identical.

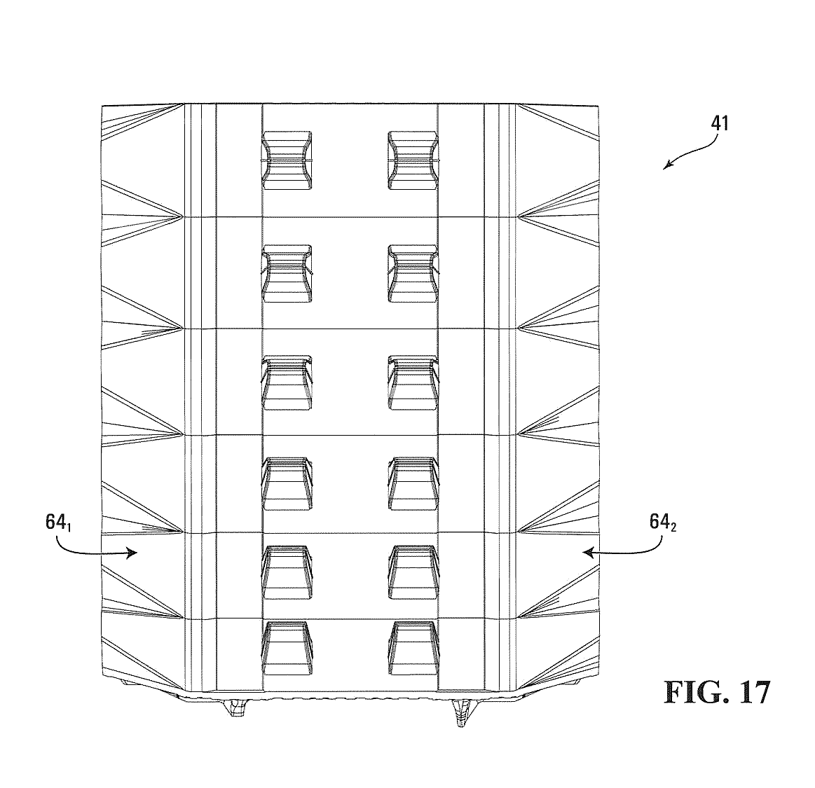

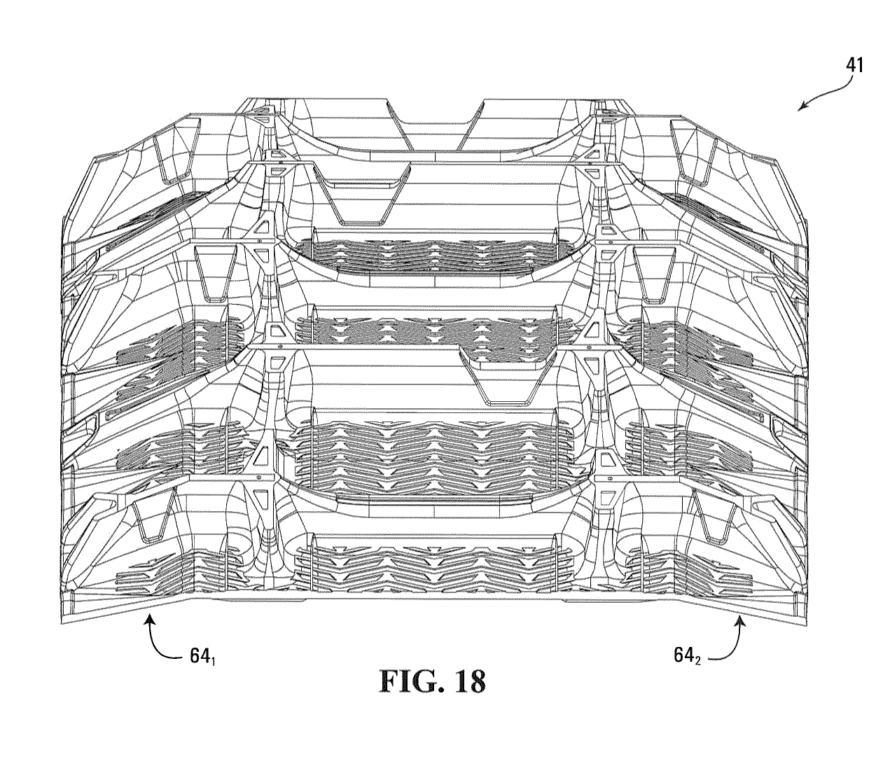

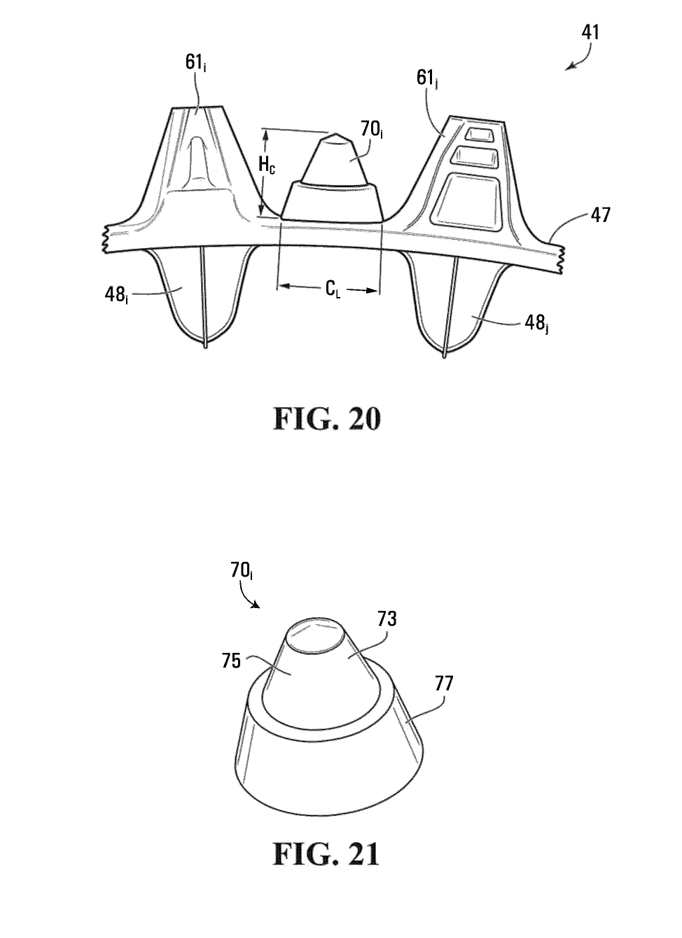

The track 41 shown in FIGS. 7 to 11 is that of a given one of the rear track assemblies 16₃, 16₄. FIGS. 17 to 23 show the track 41 of a given one of the front track assemblies 16₁, 16₂, which is similar to the track 41 of the given one of the rear track assemblies 16₃, 16₄, except that it comprises bent lateral edge portions 64₁, 64₂ adjacent its lateral edges 63₁, 63₂ to facilitate steering of the given one of the front track assemblies 16₁, 16₂ on the ground, by creating a smaller ground-contacting area. More particularly, the carcass 36 of the track 41 of the given one of the front track assemblies 16₁, 16₂ is bent inwardly proximate the lateral edges 63₁, 63₂ of the track 41 such that its inner surface 32 and ground-engaging outer surface 31 are bent inwardly.

The track 41 may be constructed in various other ways in other embodiments. For example, in some embodiments, the track 41 may comprise a plurality of parts (e.g., rubber sections) interconnected to one another in a closed configuration, the track 41 may have recesses or holes that interact with the drive wheel 42 in order to cause the track 41 to be driven (e.g., in which case the drive/guide lugs 48₁-48_{N} may be used only to guide the track 41 without being used to drive the track 41), and/or the ground-engaging outer side 47 of the track 41 may comprise various patterns of traction projections.

The drive wheel 42 is rotatable about an axis of rotation 49 for driving the track 41 in response to rotation of an axle of the ATV. In this example, the axis of rotation 49 corresponds to the axle of the ATV 10. More particularly, in this example, the drive wheel 42 has a hub which is mounted to the axle of the ATV 10 such that power generated by the prime mover 12 and delivered over the powertrain of the ATV 10 rotates the axle, which rotates the drive wheel 42, which imparts motion of the track 41. In this embodiment in which the track system 16ᵢ is mounted where a ground-engaging wheel 15ᵢ could otherwise be mounted, the axle of the ATV 10 is capable of rotating the drive wheel 42 of the track system 16ᵢ or the ground-engaging wheel 15ᵢ.

In this embodiment, the drive wheel 42 comprises a drive sprocket engaging the drive/guide lugs 48₁-48_{N} of the inner side 45 of the track 41 in order to drive the track 41. In this case, the drive sprocket 42 comprises a plurality of teeth 46₁-46_{T} distributed circumferentially along its rim to define a plurality of lug-receiving spaces therebetween that receive the drive/guide lugs 48₁-48_{N} of the track 41. The drive wheel 42 may be configured in various other ways in other embodiments. For example, in embodiments where the track 41 comprises recesses or holes, the drive wheel 42 may have teeth that enter these recesses or holes in order to drive the track 41. As yet another example, in some embodiments, the drive wheel 42 may frictionally engage the inner side 45 of the track 41 in order to frictionally drive the track 41.

The idler wheels 50₁-50₁₀ are not driven by power supplied by the prime mover 12, but are rather used to do at least one of supporting part of the weight of the ATV 10 on the ground via the track 41, guiding the track 41 as it is driven by the drive wheel 42, and tensioning the track 41. More particularly, in this embodiment, the idler wheels 50₁, 50₂ and the idler wheels 50₉, 50₁₀ are respectively front idler wheels (leading idler wheels) and rear idler wheels (trailing idler wheels) that maintain the track 41 in tension, and can help to support part of the weight of the ATV 10 on the ground via the track 41. The idler wheels 50₃-50₈ are roller wheels that roll on the inner side 45 of the track 41 along the bottom run 66 of the track 41 to apply the bottom run 66 on the ground. The idler wheels 50₁-50₁₀ move on respective ones of a plurality of idler wheel paths 51₁, 51₂ of the inner surface 32 of the carcass 36 of the track 41. Each of the idler wheel paths 51₁, 51₂ extends adjacent to respective ones of the drive/guide lugs 48₁-48_{N} to allow these lugs to guide motion of the track 41. As the roller wheels 50₃-50₈ roll on respective ones of the idler wheel paths 50₁, 50₂, these paths can be referred to as “rolling paths”.

The idler wheels 50₁-50₁₀ may be arranged in other configurations and/or the track system 16ᵢ may comprise more or less idler wheels in other embodiments.

In this embodiment, the drive/guide lugs 48₁-48_{N} and the idler wheel paths 51₁, 51₂ of the track 41 are laterally offset towards the lateral edge 63₁ of the track 41. In this example, the lateral edge 63₁ of the track 41 is an inboard lateral edge of the track 41 that is closest to a centerline 81 of the ATV 10, while the lateral edge 63₂ of the track 41 is an outboard lateral edge of the track 41 that is farthest from the centerline 81 of the ATV 10. This lateral offset may help for traction, stability and steering of the ATV 10 since it allows the track system 16ᵢ to have a ground-contacting area (i.e., “contact patch”) that emulates a ground-contacting area that a ground-engaging wheel 15ᵢ would have if mounted in place of the track system 16ᵢ. Basically, the track system 16ᵢ applies more pressure on the ground in a first half 83₁ of the width W_{T} of the track 41 that is adjacent the inboard lateral edge 63₁ of the track 41 than in a second half 83₂ of the width W_{T} of the track 41 that is adjacent to the outboard lateral edge 63₂ of the track 41, instead of applying substantially equal pressure on both halves 83₁, 83₂ of the track 41.

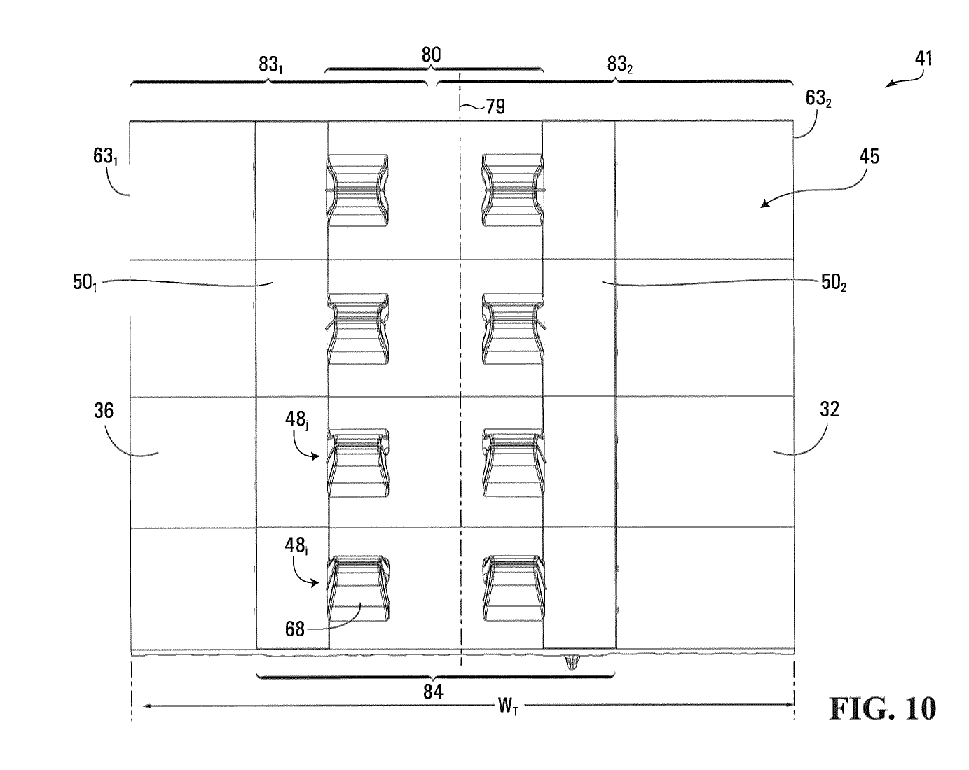

More particularly, in this embodiment, as shown in FIG. 10, the drive/guide lugs 48₁-48_{N} and the idler wheel paths 51₁, 51₂ are asymmetrically disposed relative to a centerline 79 bisecting the width W_{T} of the track 41 into its halves 83₁, 83₂. Each of a widthwise span 80 of the drive/guide lugs 48₁-48_{N} and a widthwise span 84 the idler wheel paths 51₁, 51₂ is thus asymmetrically disposed relative to the centerline 79 and located closer the inboard lateral edge 63₁ of the track 41 than to the outboard lateral edge 63₂ of the track 41.

The frame 44 supports components of the track system 16ᵢ, including the idler wheels 50₁-50₁₀. More particularly, in this embodiment, the front idler wheels 50₁, 50₂ are mounted to the frame 44 in a front longitudinal end region of the frame 44 proximate the front longitudinal end 57 of the track system 16ᵢ, while the rear idler wheels 50₉, 50₁₀ are mounted to the frame 44 in a rear longitudinal end region of the frame 44 proximate the rear longitudinal end 59 of the track system 16ᵢ. The roller wheels 50₃-50₈ are mounted to the frame 44 in a central region of the frame 44 between the front idler wheels 50₁, 50₂ and the rear idler wheels 50₉, 50₁₀. Each of the roller wheels 50₃-50₈ may be rotatably mounted directly to the frame 44 or may be rotatably mounted to a link which is pivotally mounted to the frame 44 to which is rotatably mounted an adjacent one of the roller wheels 50₃-50₈, thus forming a “tandem”.

The frame 44 is supported at a support area 39. More specifically, in this case, the frame 44 is supported by the axle of the ATV 10 to which is coupled the drive wheel 42, such that the support area 39 is intersected by the axis of rotation 49 of the drive wheel 42.

In this embodiment, the frame 44 is pivotable about a pivot axis 51 to facilitate motion of the track system 16ᵢ on uneven terrain and enhance its traction on the ground. More particularly, in this embodiment, the pivot axis 51 corresponds to the axis of rotation 49 of the drive wheel 42 and the frame 44 can pivot about the axle of the ATV 10 to which the drive wheel 42 is coupled. In other embodiments, the pivot axis 51 of the frame 44 may be located elsewhere (e.g., lower) than the axis of rotation 49 of the drive wheel 42. In yet other embodiments, the frame 44 may not be pivotable.

Also, in this embodiment, the track system 16ᵢ comprises an anti-rotation connector 52 to limit a pivoting movement of the track system 16ᵢ relative to a chassis of the ATV 10. In this example, the anti-rotation connector 52 comprises a spring and a damper and is connected between the frame 44 of the track system 16ᵢ and the chassis of the ATV 10 (e.g., via one or more mounting brackets and/or fasteners).

The track systems 16ᵢ may have various features to enhance its traction and/or other aspects of its performance in various embodiments, examples of which will now be discussed.

I. Enhanced Compaction of Snow or Other Ground Matter

In some embodiments, the track 41 may be designed to further compact snow or other ground matter on which the ATV 10 travels. This enhanced compaction of snow or other ground matter can in turn enhance traction of the ATV 10 as the traction projections 61₁-61_{M} of the track 41 can exert greater tractive forces on the compacted snow or other ground matter.

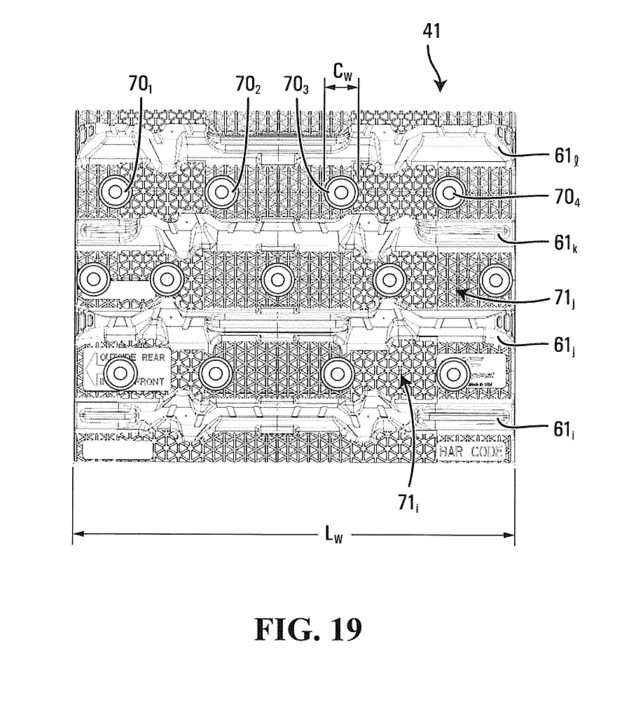

For example, in some embodiments, as shown in FIGS. 19 to 21, the ground-engaging outer side 47 of the track 41 comprises a plurality of compaction projections 70₁-70_{C} that project from the outer surface 31 to compact snow or other ground matter. The compaction projections 70₁-70_{C} increase a volume of snow or other ground matter displaced by the track 41, thereby causing more snow or other ground matter to be compacted. Notably, the compaction projections 70₁-70_{C} displace snow or other ground matter located between adjacent ones of the traction projections 61₁-61_{M} (i.e., in the traction-projection-free areas 71₁-71_{F}) towards the traction projections 61₁-61_{M} such that the displaced snow or other ground matter is compressed in smaller spaces and becomes denser. The compacted snow or other ground matter is thus able to withstand greater tractive forces exerted by the traction projections 61₁-61_{M}. In this example, the traction projections 61₁-61_{M} are shaped differently than in embodiments discussed above, but are constructed and function similarly.

More particularly, in this embodiment, the compaction projections 70₁-70_{C} are located between successive ones of the traction projections 61₁-61_{M} (i.e., in the traction-projection-free areas 71₁-71_{F}). Each compaction projection 70ᵢ is an elastomeric compaction projection in that it comprises elastomeric material 73. The compaction projections 70₁-70_{C} can be provided and connected to the carcass 36 in the mold during the track's molding process.

The compaction projection 70ᵢ has a front-to-rear dimension C_{L} in the longitudinal direction of the track 41, a side-to-side dimension C_{W} in the widthwise direction of the track 41, and a height H_{C} in the thickness direction of the track 41. In this example, the front-to-rear dimension C_{L} and the side-to-side dimension C_{W} are substantially the same. In other examples, the front-to-rear dimension C_{L} may be a width of the compaction projection 70ᵢ while the side-to-side dimension C_{wW}may be a length of the compaction projection 70ᵢ. In yet other examples, the front-to-rear dimension C_{L} may be a length of the compaction projection 70ᵢ while the side-to-side dimension C_{W} may be a width of the compaction projection 70ᵢ.

In this embodiment, the side-to-side dimension C_{W} of the compaction projection 70ᵢ is significantly less than a length L_{W} of a traction projection 61ₓ adjacent to the compaction projection 70ᵢ in the widthwise direction of the track 41. For instance, in some embodiments, a ratio C_{W}/L_{W} of the side-to-side dimension C_{W} of the compaction projection 70ᵢ to the length L_{W} of a traction projection 61ₓ may be no more than one-fifth, in some cases no more than one-sixth, in some cases no more than one-seventh in some cases no more than one-eighth, in some cases no more than one-ninth, in some cases no more than one-tenth, and in some cases even less (e.g., no more than one-fifteenth).

Moreover, in this embodiment, the side-to-side dimension C_{W} of the compaction projection 70ᵢ is significantly less than the width W_{T} of the track 41. For instance, in some embodiments, a ratio C_{W}/W_{T} of the side-to-side dimension C_{W} of the compaction projection 70ᵢ to the width W_{T} of the track 41 may be no more one-fifth, in some cases no more than one-tenth, in some cases no more than one-fifteenth, in some cases no more than one-twentieth, in some cases no more than one-twenty-fifth, and in some cases even less (e.g., no more than one-thirtieth).

The compaction projection 70ᵢ may have any suitable shape. For instance, in this embodiment, the compaction projection 70ᵢ has a shape that tapers in the thickness direction of the track 41. That is, a top portion 75 of the compaction projection 70ᵢ has a smaller cross-sectional area than a bottom portion 77 of the compaction projection 70ᵢ adjacent to the outer surface 31 of the carcass 36. In this embodiment, the compaction projection 70ᵢ is generally conical. More specifically, the compaction projection 70ᵢ comprises a plurality of conical sections with a step in between the conical sections, i.e., a section defining a discontinuity in the conical shape of the compaction projection 70ᵢ. In this particular case, the compaction projection 70ᵢ has a shape consisting of a truncated cone at a base of the compaction projection 70ᵢ with a second cone on top of the truncated cone, the second cone's base being smaller than the top of the truncated cone. The compaction projection 70ᵢ may have a different shape in other embodiments.

The compaction projections 70₁-70_{C} may be arranged in any suitable configuration. In this embodiment, adjacent ones of the compaction projections 70₁-70C between successive traction projections 61ᵢ, 61ⱼ are spaced apart in the widthwise direction of the track 41. Moreover, the compaction projections 70₁-70_{C} may be arranged such that longitudinally-successive ones of the compaction projections 70₁-70_{C} are offset, i.e., not aligned, in the widthdwise direction of the track 41. In addition, in this embodiment, the number of compaction projections 70₁-70_{C} between adjacent ones of the traction projections 61₁-61_{M} varies. In other words, the number of compaction projections 70₁-70_{C} in each of the traction-projection-free areas 71₁-71_{F} is not constant. For example, a traction-projection-free area 71ᵢ may comprise three of the compaction projections 70₁-70_{C} while an adjacent traction projection-free area 71ⱼ may comprise two of the compaction projections 70₁-70_{C}, and so on in alternation. The pattern of compaction projections 70₁-70_{C} may thus be staggered.

II. Containment of Snow or Other Ground Matter

In some embodiments, the track 41 may be designed to contain snow or other ground matter on which the ATV 10 travels by blocking lateral flow of the snow or other ground matter beyond the track 41. This enhanced containment of snow or other ground matter can in turn enhance traction of the ATV 10 as the traction projections 61₁-61_{M} of the track 41 can exert greater tractive forces on the contained snow or other ground matter.

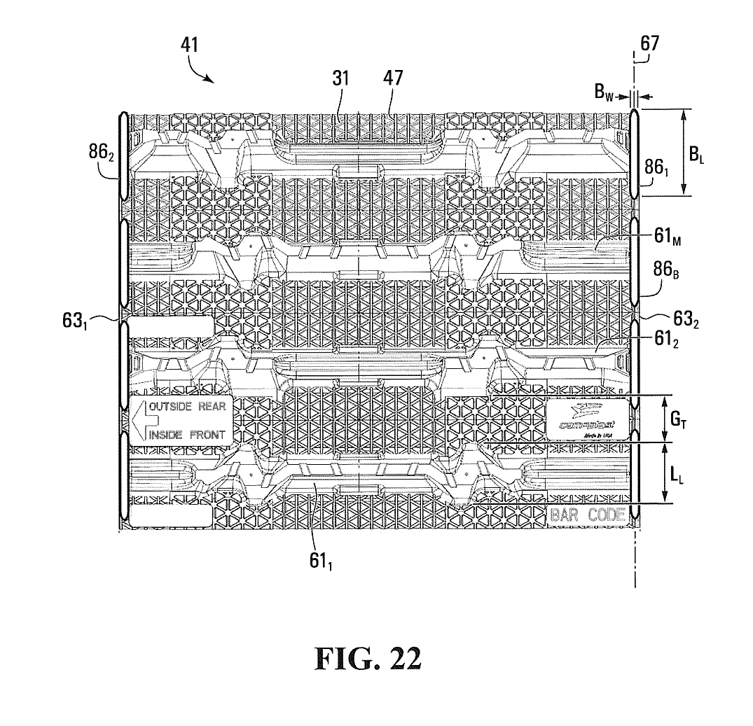

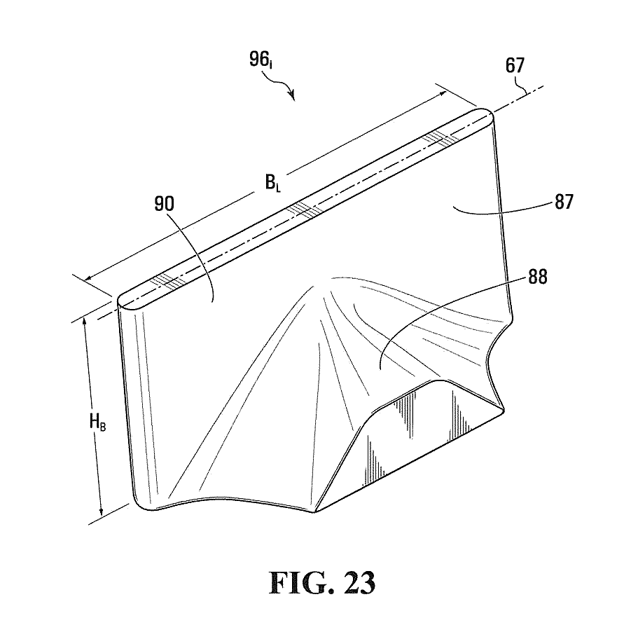

For example, in some embodiments, as shown in FIGS. 22 and 23, the ground-engaging outer side 47 of the track 41 comprises a plurality of containment barriers 86₁-86_{B} that project from the outer surface 31 to block lateral flow of snow or other ground matter beyond the track 41. The containment barriers 86₁-86_{B} keep more snow or other ground matter under the track 41. Notably, the containment barriers 86₁-86_{B} contain snow or other ground matter between adjacent ones of the traction projections 61₁-61_{M} (i.e., in the traction-projection-free areas 71₁-71_{F}) such that the traction projections 61 ₁-61_{M} can exert greater tractive forces on the contained snow or other ground matter.

More particularly, in this embodiment, the containment barriers 86₁-86_{B} are located adjacent to the lateral edges 63₁, 63₂ of the track 41 to contain snow or other ground matter between the lateral edges 63₁, 63₂ of the track 41. In this example, the containment barriers 86₁-86_{B} are located at longitudinal ends of respective ones of the traction projections 61₁-61_{M}. Each containment barrier 86ᵢ is an elastomeric compaction projection in that it comprises elastomeric material 87. The containment barriers 86₁-86_{B} can be provided and connected to the carcass 36 in the mold during the track's molding process.

The containment barrier 86ᵢ is elongated transversally to the widthwise direction of the track 41. More particularly, the containment barrier 86ᵢ has a longitudinal axis 67 that is transversal to the widthwise direction of the track 41 and defines its length B_{L}, a width B_{W} normal to its longitudinal axis 67, and a height H_{B} in the thickness direction of the track 41. In this example, the longitudinal axis 67 of the containment barrier 86ᵢ is substantially normal to the widthwise direction of the track 41, i.e., substantially parallel to the longitudinal direction of the track 41.

In this embodiment, the containment barrier 86ᵢ protrudes, in the longitudinal direction, beyond a traction projection 61ₓ at the end of which it is located. As such, the length B_{L} of the containment barrier 86ᵢ is greater than a front-to-rear dimension L_{L} of the traction projection 61ₓ. For example, in some cases a ratio B_{L}/L_{L} of the length of the containment barrier 86ᵢ to the front-to-rear dimension L_{L} of the traction projection 61ₓ may be at least 1.2, in some cases at least 1.3, in some cases at least 1.4, in some cases at least 1.5, and in some cases even more (e.g., 2 or more).

The containment barriers 86₁-86_{B} are arranged to occupy a significant part of a gap G_{T} in the longitudinal direction of the track 41 between adjacent ones of the traction projections 61₁-61_{M}. For instance, in this embodiment, adjacent 3o containment barriers 86ᵢ, 86ⱼ occupy a significant part of the gap G_{T} between adjacent traction projections 61ᵢ, 61ⱼ. For example, the containment barriers 86ᵢ, 86ⱼ occupy at least a majority of the gap G_{T} between the traction projections 61ᵢ, 61ⱼ, in some cases at least two-thirds the gap G_{T} between the traction projections 61ᵢ, 61ⱼ, in some cases at least three-quarters of the gap G_{T} between the traction projections 61ᵢ, 61ⱼ, and in some cases even more (e.g., up to an entirety of the gap G_{T} between the traction projections 61ᵢ, 61ⱼ).

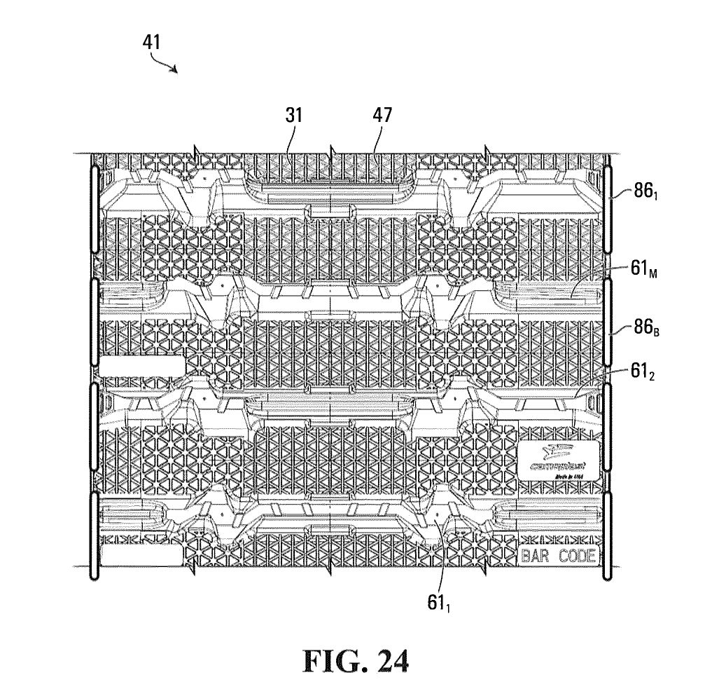

In a variant, with additional reference to FIG. 24, a single containment barrier 86ᵢ may occupy at least majority of the gap G_{T} between the traction projections 61ᵢ, 61ⱼ, in some cases at least two-thirds the gap G_{T} between the traction projections 61ᵢ, 61ⱼ, in some cases at least three-quarters of the gap G_{T} between the traction projections 61ᵢ, 61ⱼ, and in some cases even more (e.g., up to an entirety of the gap G_{T} between the traction projections 61ᵢ, 61ⱼ).

In addition, in some embodiments, the length B_{L} of a containment barrier 86ᵢ may be no more than a pitch P_{T} of the traction projections 61₁-61_{M}, which isdefined between adjacent ones of the traction projections 61₁-61_{M}. For instance, a ratio P_{T}/B_{L} between the pitch P_{T} of the traction projections 61 ₁-61_{M} and the length B_{L} of the containment barrier 86ᵢ may be at least 1, in some cases at least 1.2, in some cases at least 1.4, in some cases at least 1.6, in some cases at least 1.8, and in some cases even more (e.g., at least 2).

The containment barrier 86ᵢ may have any suitable shape. In this embodiment, the containment barrier 86ᵢ comprises a wall 90 and a transitional member 88 which merges the wall 90 with the traction projection 61ᵢ at the end of which the containment barrier 86ᵢ is located. In this example, the wall 90 is flat and elongated in the longitudinal direction of the track 41. The transitional member 88 of the containment barrier 86ᵢ has a generally trapezoidal shape with its widest side adjacent to the outer surface 31 of the carcass 36. The containment barrier 86ᵢ may have any other suitable shape in other embodiments (e.g., the wall 90 may be curved).

III. Enhanced Compaction and Containment of Snow or Other Ground Matter

In some embodiments, the track 41 may be designed to enhance both compaction and containment of snow or other ground matter on which the ATV 10 travels.

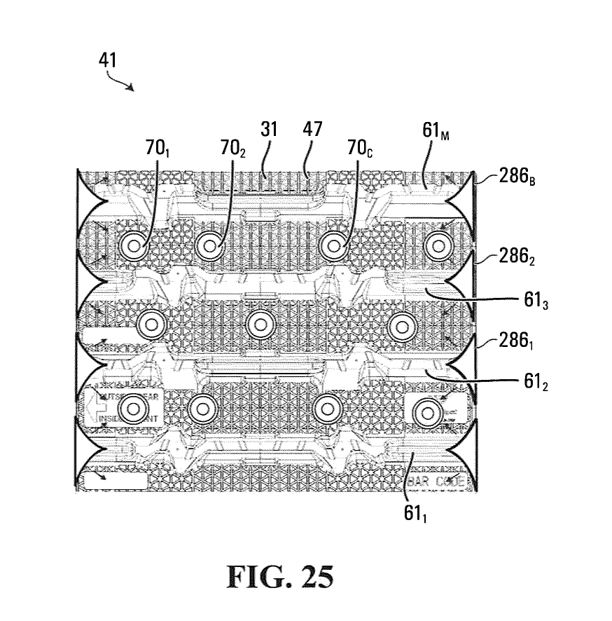

For example, in some embodiments, as shown in FIG. 25, the ground-engaging outer side 47 of the track 41 comprises (1) the compaction projections 70₁-70_{C} that project from the outer surface 31 to compact snow or other ground matter; and (2) containment barriers 286₁-286_{B} that project from the outer surface 31 to block lateral flow of snow or other ground matter beyond the track 41.

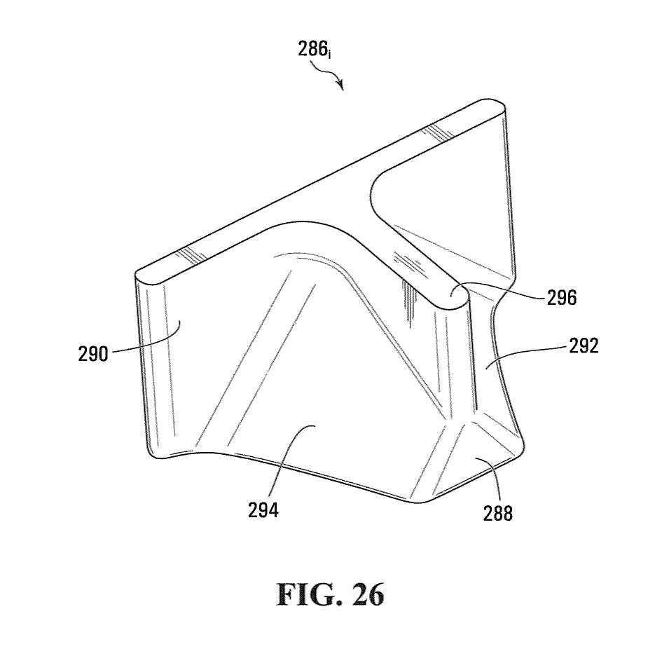

In this embodiment, each containment barrier 286ᵢ has a different shape than that of the containment barrier 86ᵢ described above. With reference to FIG. 26, the containment barrier 286ᵢ comprises a wall 290 and a transitional member 288 which merges the wall 290 with the traction projection 61; at the end of which the containment barrier 286ᵢ is located. The transitional member 288 also defines two side surfaces 292, 294 for aiding in containing snow or other ground matter within a traction-projection-free area 71ᵢ. To this end, the side surfaces 292, 294 are disposed at an oblique angle relative to the wall 290. While in this embodiment, the side surfaces 292, 294 are straight surfaces, in other embodiments the side surfaces 292, 294 may be curved surfaces.

By virtue of their shape, the containment barriers 286₁-286_{B} may cooperate with the compaction projections 70₁-70_{C} to further enhance the compaction of snow or other ground matter. For example, as shown in FIG. 25, in addition of being blocked from flowing laterally outwards beyond the track 41 by a containment barrier 286ᵢ, snow or other ground matter disposed in a traction-projection-free area 71ᵢ may also be redirected by the side surfaces 292, 294 of the containment barrier 286ᵢ towards a compaction projection 70ᵢ located in the traction-projection-free area 71ᵢ. In turn, this may provide further compaction of the snow or other ground matter by the compaction projections 70₁-70_{C}.

IV. Progressive Compaction of Snow or Other Ground Matter

In some embodiments, the track system 16ᵢ may be designed to progressively compact snow or other ground matter on which the ATV 10 travels while also allowing a greater amount of snow to be captured by the track 41. This progressive compaction of snow or other ground matter may enhance traction of the ATV 10.

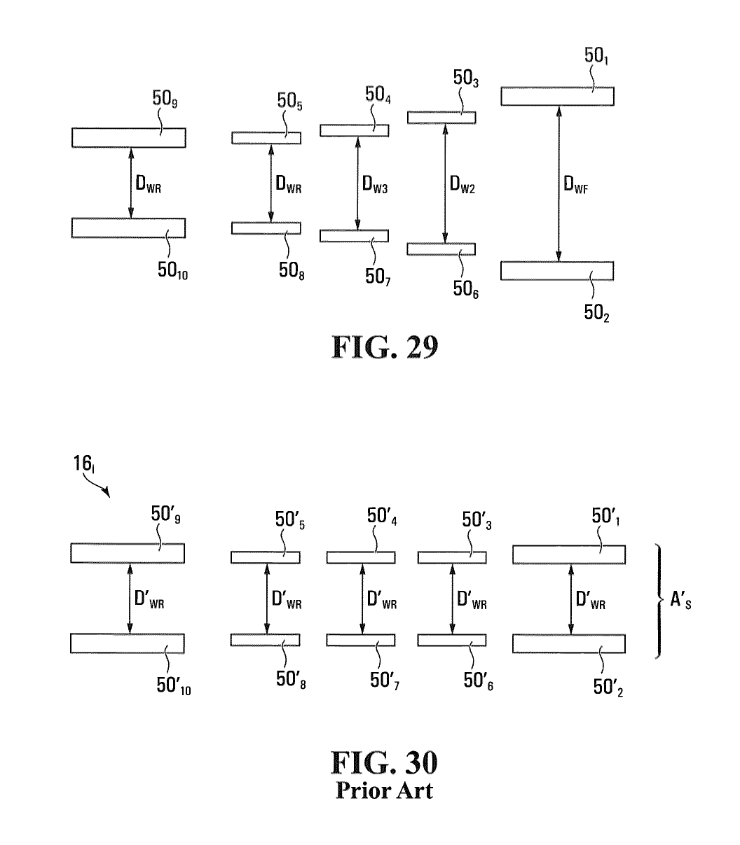

For instance, in some embodiments, as shown in FIGS. 28 and 29, a distance in the widthwise direction of the track system 16ᵢ between laterally-adjacent ones of the idler wheels 50₁-50₁₀ varies in the longitudinal direction of the track system 16ᵢ for at least a part of the length of the track system 16ᵢ. As used here, the expression “laterally-adjacent” idler wheels refers to two of the idler wheels 50₁-50₁₀ that are adjacent to one another in the widthwise direction of the track system 16ᵢ such that there are no idler wheels in between them in the widthwise direction of the track system 16ᵢ.

More particularly, in this embodiment, the distance in the widthwise direction of the track system 16ᵢ between laterally-adjacent idler wheels gradually decreases in a front-to-rear direction of the track system 16ᵢ for at least a part of the length of the track system 16ᵢ starting at the front longitudinal end 57 of the track system 16ᵢ. This allows snow captured between laterally-adjacent idler wheels of the track system 16ᵢ to be progressively compacted as the snow or other ground matter is moved rearwardly along the track system 16ᵢ. In addition, this may increase an “attack section” A_{S} of the track 41 that is configured to engage the snow or other ground matter on which the ATV 10 travels before a remainder of the track system 16ᵢ.

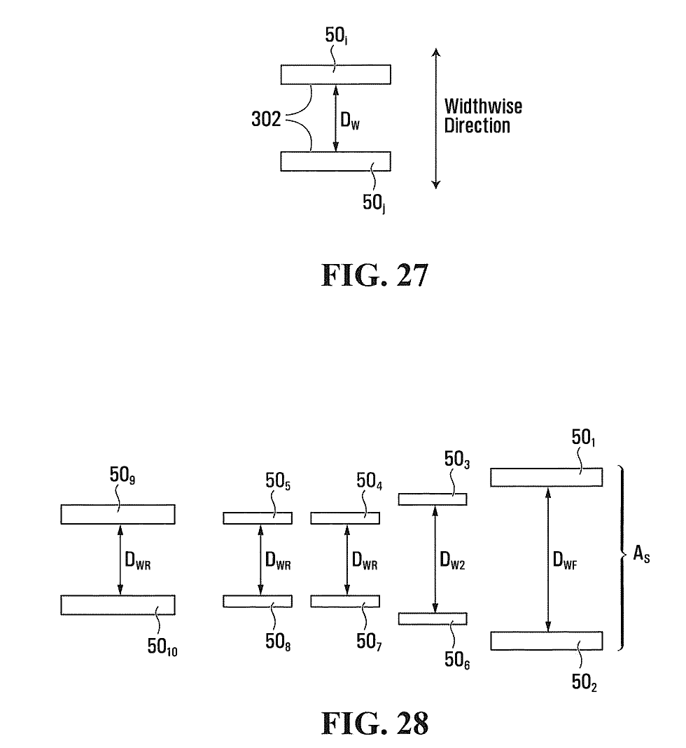

As shown in FIG. 27, a pair of laterally-adjacent idler wheels 50ᵢ, 50ⱼ define a lateral distance D_{W} measured between an inner lateral surface 302 of each of the idler wheels 50ᵢ, 50ⱼ in the widthwise direction of the track system 16ᵢ. For instance, with additional reference to FIG. 28, a rearmost pair of laterally-adjacent idler wheels 50₉, 50₁₀ (i.e., the trailing idler wheels 50₉, 50₁₀) defines a lateral distance D_{WR} between the trailing idler wheels 50₉, 50₁₀. The lateral distance D_{WR} is the smallest lateral distance D_{W} of any pair of laterally-adjacent idler wheels 50ᵢ, 50ⱼ of the track system 16ᵢ. Other pairs of laterally-adjacent idler wheels may have a lateral distance equal to the lateral distance D_{WR} of the rearmost pair of laterally-adjacent idler wheels 50₉, 50₁₀. For instance, the lateral distance D_{W} of respective pairs of laterally-adjacent idler wheels 50₅,50₈ and 50₄,50₇ is equal to the lateral distance D_{WR} of the rearmost pair of laterally-adjacent idler wheels 50₉, 50₁₀. Thus, in some cases, the lateral distance D_{W} of a majority of the laterally-adjacent idler wheels is equal to the lateral distance D_{WR} of the rearmost pair of laterally-adjacent idler wheels 50₉, 50₁₀. As such, the lateral distance D_{WR} may be referred to as a “base” lateral distance.

The lateral distance D_{W} between some of the pairs of laterally-adjacent idler wheels is greater than the base lateral distance D_{WR}. More specifically, a frontmost pair of laterally-adjacent idler wheels 50₁, 50₂ (i.e., leading idler wheels 50₁, 50₂) defines a lateral distance D_{WF} between the leading idler wheels 50₁, 50₂ that is greater than the lateral distance D_{W} of any other pair of laterally-adjacent idler wheels. The lateral distance D_{W} of laterally-adjacent idler wheels successive to the leading idler wheels 50₁, 50₂ gradually decreases in the front-to-rear direction of the track system 16ᵢ until the lateral distance D_{W} between laterally-adjacent idler reaches the base lateral distance D_{WR}. For example, the pair of laterally-adjacent idler wheels 50₃, 50₆ which is adjacent to the frontmost pair of idler wheels 50₁, 50₂ defines a lateral distance D_{W2} that is smaller than the lateral distance D_{WF} between the leading idler wheels 50₁, 50₂. The lateral distance D_{W} of the next set of laterally-adjacent idler wheels 50₄, 50₇ is equal to the uniform lateral distance D_{WR} and smaller than the lateral distance D_{W2} (D_{WF}>D_{W2}>D_{WR}).

The lateral distance D_{W} of the next set of adjacent idler wheels 50₅, 50₈ is also equal to the base lateral distance D_{WR} and so on until the trailing idler wheels 50₉, 50₁₀.

Thus, the lateral distance D_{WF} between the leading idler wheels 50₁, 50₂ is greater than the base lateral distance D_{WR} between the trailing idler wheels 50₉, 50₁₀. For instance, a ratio D_{WF}/D_{WR} between the lateral distance D_{WF} between the leading idler wheels 50₁, 50₂ and the base lateral distance D_{WR} may be greater than 1.2, in some cases greater than 1.4, in some cases greater than 1.6, in some cases greater than 1.8, in some cases greater than 2, and in some cases even more.

While in this embodiment the variation of the lateral distance D_{W} between laterally-adjacent idler wheels has been described in respect of the two frontmost pairs of laterally-adjacent idler wheels (i.e., leading idler wheels 50₁, 50₂ and adjacent idler wheels 50₃, 50₆), any number of pairs of laterally-adjacent idler wheels may define a lateral distance that is not equal to the base lateral distance D_{WR}. For instance, with additional reference to FIG. 29, in some embodiments, the lateral distance D_{W} of the three frontmost pairs of laterally-adjacent idler wheels may vary. In other embodiments, more or less sets of laterally-adjacent idler wheels may define a lateral distance D_{W} that varies from the uniform lateral distance D_{WR}.

The attack section A_{S} of the track 41 is a portion of the track 41 that is adjacent the front longitudinal end 57 of the track system 16ᵢ and extends along the bottom run 66 of the track 41. The variation of the lateral distance D_{W} between some of the laterally-adjacent idler wheels can increase an extent of the attack section of the track 41. For instance, as depicted in FIG. 30, in a conventional track system 16ᵢ′, leading idler wheels 50₁′, 50₂′ are positioned such that a lateral distance D_{WR}′ defined between the leading idler wheels 50₁′, 50₂′ is the same lateral distance D_{WR}′ defined between trailing idler wheels 50₉′, 50₁₀′ of the track system 16ᵢ′. As a result, a width of an attack section A_{S}′ of such a conventional track system 16ᵢ′ is limited to the lateral distance D_{WR}′. However, the variation of the lateral distance D_{W} between some of the laterally-adjacent idler wheels of the track system 16ᵢ can increase the extent of the attack section A_{S}. For example, referring back to FIG. 28, a width of the attack section A_{S} is increased as a result of the expanded lateral distance D_{WF} of the leading idler wheels 50₁, 50₂.

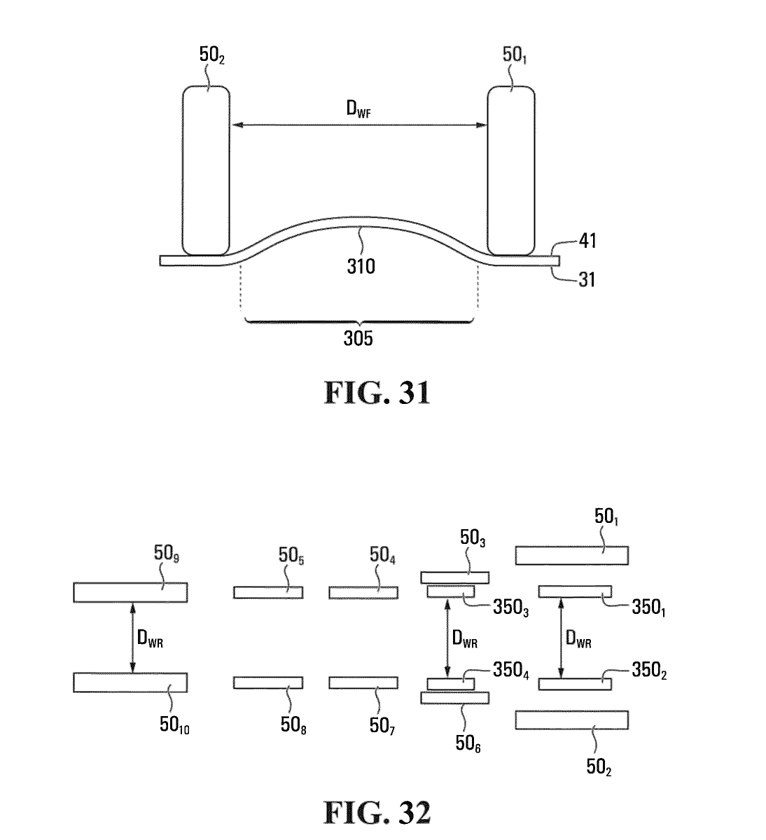

In some embodiments, as shown in FIG. 31, the variation of the lateral distance D_{W} between some of the laterally-adjacent idler wheels may allow the track 41 to deform such as to capture more snow or other ground matter on which the ATV 10 travels. More specifically, the track 41 has a tendency to bend at a central portion 305 of the track 41 in the widthwise direction of the track 41 between a pair of laterally-adjacent idler wheels defining a lateral distance D_{W} greater than the base lateral distance D_{WR} (e.g., the leading idler wheels 50₁, 50₂). This bending of the track 41 causes the track 41 to form a concave shape 310 at the central portion 305 of the track 41. This may allow a greater amount of snow or other ground matter to be captured by frontmost laterally-adjacent idler wheels.

In a variant, with additional reference to FIG. 32, the track system 16, may comprise additional idler wheels 350₁-350_{A} that are positioned coaxially between laterally-adjacent idler wheels defining a lateral distance D_{W} varying from the base lateral distance D_{R} (e.g., idler wheels 50₁, 50₂, 50₃, 50₆). For instance, in one example of implementation, additional idler wheels 350₁, 350₂ are located coaxially between leading idler wheels 50₁, 50₂ and additional idler wheels 350₃, 350₄ are located coaxially between idler wheels 50₃, 50₆. As such, the additional idler wheels 350₁-350_{A} form pairs of laterally-adjacent idler wheels. More specifically, a distance between laterally-adjacent ones of the additional idler wheels 350₁-350_{A} is equal to the base lateral distance D_{WR}. In addition, each additional idler wheel 350ᵢ of defines a diameter that is smaller than a diameter of the idler wheels 50₁-50₁₀ between which they are located. This may allow the track 41 to deform in between the laterally-adjacent idler wheels that define a lateral distance D_{W} greater than the base lateral distance D_{WR} such as to capture more snow or other ground-matter on which the ATV 10 travels.

V. Longitudinally-Uniform Pressure on Track

In some embodiments, the track system 16ᵢ may be designed to more evenly distribute pressure along the longitudinal direction of the track system 16ᵢ.

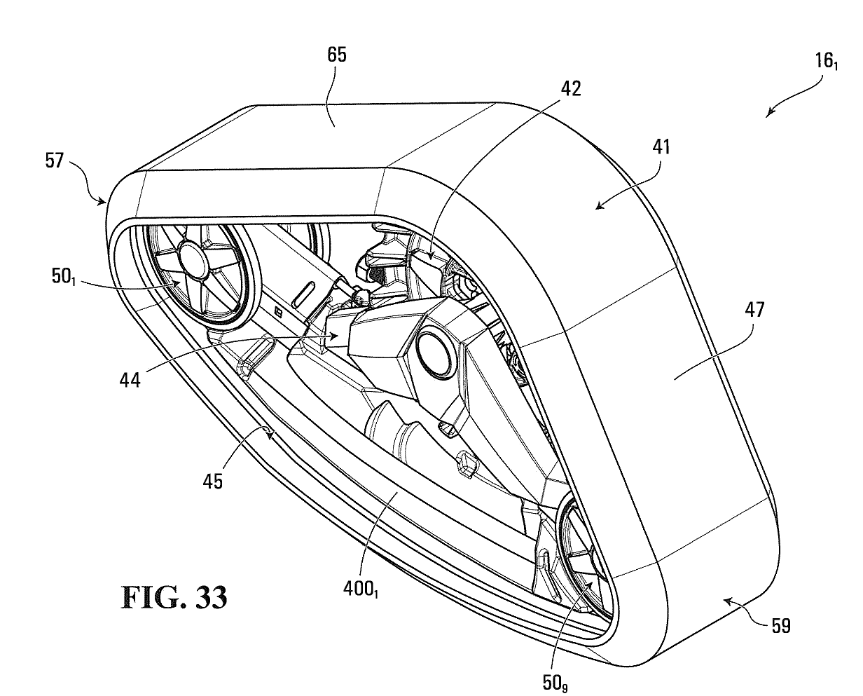

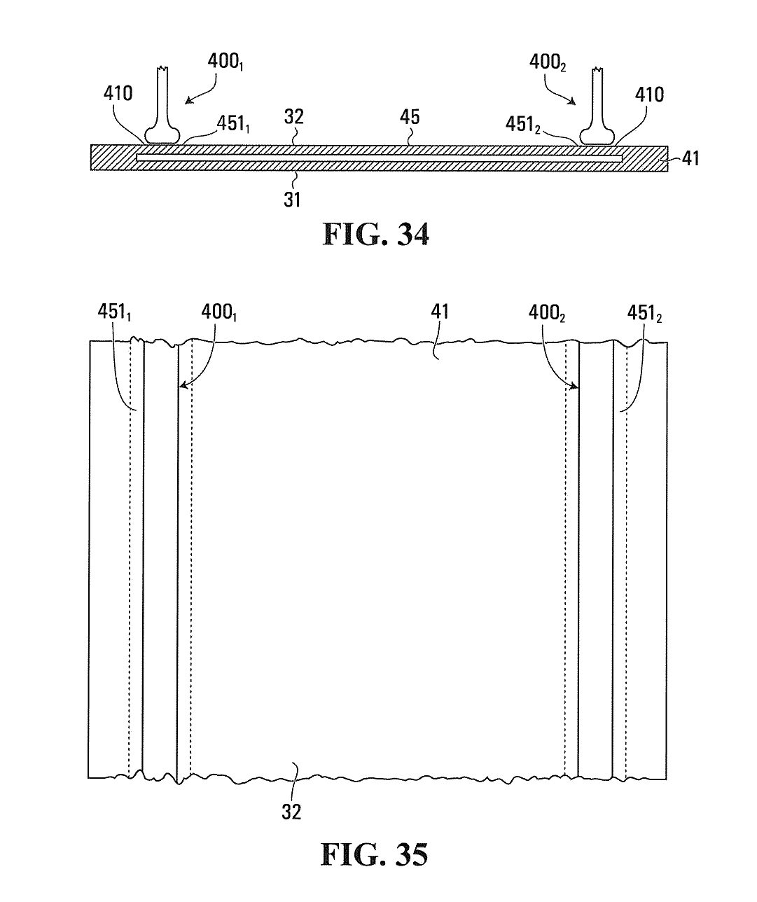

For instance, in some embodiments, with additional reference to FIGS. 33 and 34, the track system 16ᵢ may comprise a plurality of sliders 400₁, 400₂ in place of or in addition to some or all of the idler wheels 50₃-50₈ configured to slide on the inner surface 32 of the track 41 along the bottom run 66 of the track 41 to apply the bottom run 66 onto the ground on which the ATV 10 travels. The sliders 400₁, 400₂ slide on respective ones of a plurality of sliding paths 451₁, 451₂ of the inner surface 32 of the carcass 36 of the track 41. The sliders 400₁, 400₂ are elongated sliding members that may sometimes be referred to as “slide rails” in view of their elongated shape.

The slide rails 400₁, 400₂ may be mounted to the frame 44 of the track system 16ᵢ via any suitable method (e.g., fasteners, welding, etc.) or may be made integrally with the frame 44. Moreover, in this embodiment, the slide rails 400₁, 400₂ are curved upwardly in a front region of the track system 16ᵢ to guide the track 41 towards the leading idler wheels 50₁, 50₂.

In this embodiment, the track 41 is free of slider-engaging members, such as slide clips (e.g., metal clips), spaced apart along the longitudinal direction of the track 41 for engagement with the slide rails 400₁, 400₂, as are typically implemented on conventional snowmobile tracks and other tracks engaging slide rails.

More particularly, in this embodiment, friction between the slide rails 400₁, 400₂ and the sliding paths 451₁, 451₂ of the track 41 is reduced to enhance operation. For example, in some embodiments, a coefficient of friction μₛᵣ of the slide rails 400₁, 400₂ with the sliding paths 451₁, 451₂ of the track 41 may be no more than 0.4, in some cases no more than 0.3, in some cases no more than 0.2, in some cases no more than 0.1, and in some cases even less. The coefficient of friction μₛᵣ of the slide rails 400₁, 400₂ with the sliding paths 451₁, 451₂ of the track 41 may have any other suitable value in other embodiments.

Reduction of friction between the slide rails 400₁, 400₂ and the sliding paths 451₁, 451₂ of the track 41may be achieved in any suitable way. For instance, in some embodiments, the sliding paths 451₁, 451₂ of the track 41 may comprise a friction-reducing material 410 to contact the slide rails 400₁, 400₂. The friction-reducing material 410 may be implemented in any suitable way.

For example, in some embodiments, at least part of the elastomeric material of the track 41, including the elastomeric material 38 of the carcass 36, may include “slipper” rubber that implements the friction-reducing material 410 of the sliding paths 451₁, 451₂ of the track 41. The slipper rubber 410 exhibits a migration of lubricant (e.g., oil) contained within itself to the inner surface 32 of the carcass 36 in use. This helps to reduce friction between the slide rails 400₁, 400₂ and the track 41. Any suitable type of slipper rubber which exhibits oil migration to its surface may be used.

As another example, in some embodiments, instead of or in addition to slipper rubber. the friction-reducing material 410 may be implemented by a layer (e.g., a coating) of polytetrafluoroethylene (PTFE) or any other suitable low-friction material at the sliding paths 451₁, 451₂ of the track 41.

In some examples of implementation, the friction-reducing material 410 (e.g., slipper rubber, low-friction layer, etc.) may be present only in the sliding paths 451₁, 451₂ of the track 41 but not outside of the sliding paths 451₁, 451₂ of the track 41. In such cases, the coefficient of friction μₛᵣ of the slide rails 400₁, 400₂ with the sliding paths 451₁, 451₂ of the track 41 is lower than a coefficient of friction pₛr of the slide rails 400₁, 400₂ with parts of the inner surface 32 of the track 41 outside of the sliding paths 451₁, 451₂ of the track 41. In other examples of implementation, the friction-reducing material 410 (e.g., slipper rubber, low-friction layer, etc.) may be present on the sliding paths 451₁, 451₂ of the track 41 and outside of the sliding paths 451₁, 451₂ of the track 41 (e.g., all over the inner surface 32 o the track 41).

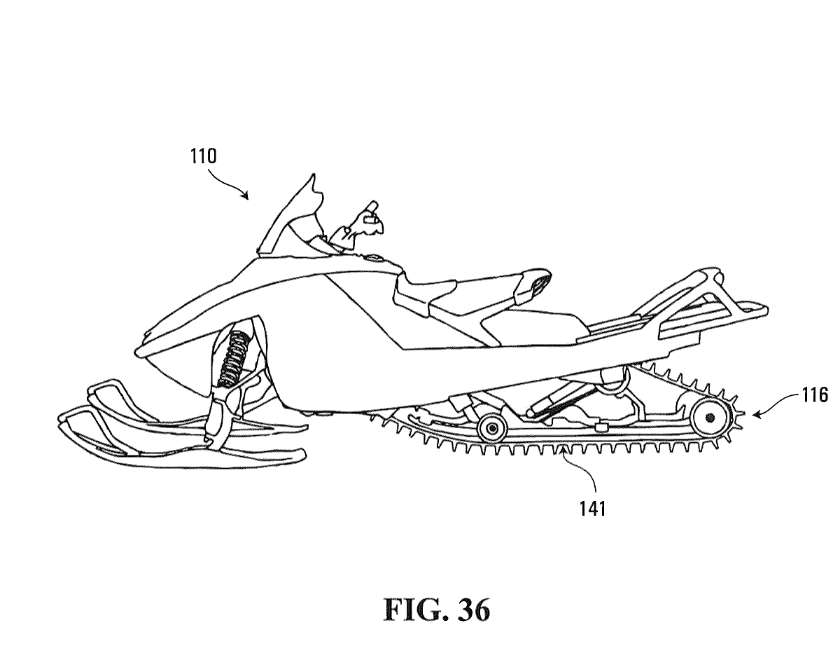

While in this embodiment the track system 16ᵢ is part of an ATV, in other embodiments, a track system constructed according to principles discussed herein may be used as part of other types of off-road vehicles. For example, in some embodiments, as shown in FIG. 36, a track system 116 including a track 141 constructed according to principles discussed herein may be used as part of a snowmobile 110.

The ATV 10 and the snowmobile 110 considered above are examples of recreational vehicles. While they can be used for recreational purposes, such recreational vehicles may also be used for utility purposes in some cases. Also, while these examples pertain to recreational vehicles, a track system constructed according to principles discussed herein may be used as part of off-road vehicles other than recreational ones.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A track for traction of an off-road vehicle, the track being mountable around a plurality of track-contacting wheels which includes a drive wheel for driving the track, the track comprising elastomeric material allowing the track to flex around the track-contacting wheels, the track comprising:
an inner surface for facing the track-contacting wheels;
a ground-engaging outer surface for engaging the ground;
a plurality of traction projections projecting from the ground-engaging outer surface and distributed in a longitudinal direction of the track; and
a plurality of compaction projections projecting from the ground-engaging outer surface to compact matter on the ground.

2. The track of claim 1, wherein each compaction projection is located between successive ones of the traction projections in the longitudinal direction of the track to displace the matter on the ground towards the successive ones of the traction projections.

3. The track of claim 1, wherein a dimension of each compaction projection in the longitudinal direction of the track and a dimension of the compaction projection in a widthwise direction of the track are substantially the same.

4. The track of claim 1, wherein a dimension of each compaction projection in the longitudinal direction of the track and a dimension of the compaction projection in a widthwise direction of the track are different.

5. The track of claim 1, wherein a dimension of each compaction projection in a widthwise direction of the track is less than a dimension of an adjacent one of the traction projections that is adjacent to the compaction projection in the widthwise direction of the track.

6. The track of claim 5, wherein a ratio of the dimension of the compaction projection in the widthwise direction of the track over the dimension of the adjacent one of the traction projections in the widthwise direction of the track is no more than one-fifth.

7. The track of claim 5, wherein a ratio of the dimension of the compaction projection in the widthwise direction of the track over the dimension of the adjacent one of the traction projections in the widthwise direction of the track is no more than one-seventh.

8. (canceled)

9. The track of claim 1, wherein a dimension of each compaction projection in a widthwise direction of the track is less than a width of the track.

10. The track of claim 9, wherein a ratio of the dimension of the compaction projection in the widthwise direction of the track over the width of the track is no more than one-fifth.

11. The track of claim 9, wherein a ratio of the dimension of the compaction projection in the widthwise direction of the track over the width of the track is no more than one-tenth.

12. (canceled)

13. The track of claim 1, wherein each compaction projection tapers in a thickness direction of the track.

14. The track of claim 1, wherein a top portion of each compaction projection is smaller in cross-section than a bottom portion of the compaction projection.

15. The track of claim 1, wherein each compaction projection is generally conical.

16. The track of claim 15, wherein the compaction projection comprises a plurality of conical sections with a step in between adjacent ones of the conical sections.

17. (canceled)

18. The track of claim 1, wherein adjacent ones of the compaction projections between two of the traction projections in the longitudinal direction of the track are spaced apart in a widthwise direction of the track.

19. The track of claim 1, wherein longitudinally-successive ones of the compaction projections are offset in a widthwise direction of the track.

20. The track of claim 1, comprising a plurality of containment barriers projecting from the ground-engaging outer surface to block lateral flow of the matter on the ground beyond the track.

21. The track of claim 20, wherein the containment barriers contain the matter on the ground between successive ones of the traction projections.

22. The track of claim 20, wherein the containment barriers are located adjacent to lateral edges of the track to contain the matter on the ground between the lateral edges of the track.

23. The track of claim 20, wherein the containment barriers are located at longitudinal ends of respective ones of the traction projections.

24. The track of claim 20, wherein each containment barrier is elongated transversally to a widthwise direction of the track.

25. The track of claim 24, wherein a longitudinal axis of the containment barrier is substantially normal to the widthwise direction of the track.

26. The track of claim 20, wherein each containment barrier is adjacent to a given one of the traction projections and protrudes beyond the given one of the traction projections in the longitudinal direction of the track.

27. (canceled)

28. (canceled)

29. The track of claim 20, wherein at least a majority of a gap between adjacent ones of the traction projections is occupied by at least one of the containment barriers.

30. (canceled)

31. (canceled)

32. The track of claim 20, wherein a length of each containment barrier is no more than a pitch of the traction projections.

33. (canceled)

34. (canceled)

35. (canceled)

36. The track of claim 20, wherein each containment barrier comprises a wall and a transitional member which merges the wall with a given one of the traction projections.

37. A track for traction of an off-road vehicle, the track being mountable around a plurality of track-contacting wheels which includes a drive wheel for driving the track, the track comprising elastomeric material allowing the track to flex around the track-contacting wheels, the track comprising:
an inner surface for facing the track-contacting wheels;
a ground-engaging outer surface for engaging the ground;
a plurality of traction projections projecting from the ground-engaging outer surface and distributed in a longitudinal direction of the track; and
a plurality of containment barriers projecting from the ground-engaging outer surface to block lateral flow of matter on the ground beyond the track.

38. (canceled)

39. A track system for traction of an off-road vehicle, the track system comprising:
a track comprising:
elastomeric material allowing the track to flex when moving around the track system;
a ground-engaging outer surface for engaging the ground;
an inner surface opposite to the ground-engaging outer surface; and
a plurality of traction projections projecting from the ground-engaging outer surface and distributed in a longitudinal direction of the track;
and
a plurality of wheels around which the track is disposed, the plurality of wheels comprising:
a drive wheel for driving the track; and
a plurality of idler wheels;
wherein a distance in a widthwise direction of the track system between laterally-adjacent ones of the idler wheels varies in a longitudinal direction of the track system.

40. (canceled)

41. (canceled)

42. (canceled)

43. (canceled)

44. (canceled)

45. (canceled)

46. (canceled)

47. (canceled)

48. (canceled)

49. (canceled)

50. (canceled)
